(19) United States
(12) Patent Application Publication
(10) Pub. No.: US 2014/0364229 A1
(43) Pub. Date: Dec. 11, 2014

(54) Game Apparatus, Storage Medium Storing Game Program and Game Controlling Method

(71) Applicant: NINTENDO CO., LTD., Kyoto (JP)

(72) Inventors: Masahiro YAMAMOTO, Tokyo (JP); Yuta SAKAMOTO, Tokyo (JP); Takanori MORI, Tokyo (JP)

(21) Appl. No.: 14/469,919

(22) Filed: Aug. 27, 2014

Related U.S. Application Data
(63) Continuation of application No. 12/707,074, filed on Feb. 17, 2010.

(30) Foreign Application Priority Data
Nov. 13, 2009 (JP) 2009-259742

(51) Int. Cl. A63F 13/525; A63F 13/213; H04N 5/232; G06K 9/00; G06T 15/20; G06F 3/01

(52) U.S. Cl. CPC A63F 13/525; G06T 15/205; G06F 3/013; H04N 5/23229; G06K 9/00597; G06K 9/00228; A63F 13/213; G06T 2200/04; G06T 2215/16; G06T 2219/2016
USPC 463/32

(57) ABSTRACT

A game apparatus includes a CPU, and images a face image of a player with an inward camera provided between a first LCD and a second LCD according to an instruction from the CPU. The CPU specifies a position of the eyes of the player from the face image, and decides a position of a virtual camera in correspondence to the specified position of the eyes. In a three-dimensional virtual space, a gazing point is fixedly decided, and a game screen is displayed on the first LCD and the second LCD such that the three-dimensional virtual space is fixed with respect to the display surface. If the position of the eyes of the player is in a predetermined position (range) with respect to the display surface, a predetermined letter or the like is represented by a combination of objects, etc. on the game screen.

### CROSS REFERENCE OF RELATED APPLICATION

This application is a continuation of U.S. patent application Ser. No. 12/707,074 filed Feb. 17, 2010, which claims priority to Japanese Patent Application No. 2009-259742 filed Nov. 13, 2009, the contents of each of which are incorporated herein by reference.

### BACKGROUND OF THE INVENTION

1. Field of the Invention

The present invention relates to a game apparatus, a storage medium storing a game program, and a game controlling method. More specifically, the present invention relates to a game apparatus, a storage medium storing a game program, and a game controlling method which utilize an image obtained by imaging a player in game processing.

2. Description of the Related Art

One example of a game apparatus of the related art is disclosed in a Japanese Patent Laying-open No. 2004-313778 [A63F 13/00] (document 1) laid-open on Nov. 11, 2004. An electronic playing appliance of this document 1 detects a playing posture of a player by photoelectric sensors for posture detection provided to the body of the appliance, and changes a viewpoint of a display screen in correspondence with the detected posture of the playing. For example, the viewpoint is set such that in response to the player leaning to right, the display image is also inclined to the right, and in response to the player leaning forward, the position of the horizon slides upward on the screen.

However, in the electronic playing appliance disclosed in the document 1, in correspondence with the posture of the player, the viewpoint is merely changed to vary the displayed image and to give a realistic sensation, and the game is not played in correspondence with the changes of the posture of the player.

### SUMMARY OF THE INVENTION

Therefore, it is a primary object of the present invention is to provide a novel game apparatus, a novel storage medium storing a game program and a novel game controlling method.

Furthermore, another object of the present invention is to provide a game apparatus, a storage medium storing a game program and a game controlling method which are able to effectively utilize a posture of a player himself or herself in the game.

A first invention is a game apparatus having a displayer, a display controller, a position specifier, a virtual camera controller, a designator, and a game processor. The displayer displays an image. The imager images at least a part of a player. The display controller displays a virtual space on the displayer. The position specifier specifies a position of a predetermined image imaged by the imager. For example, a position as to the predetermined image included in the imaged image is specified. The virtual camera controller controls a virtual camera according to the position specified by the position specifier. The designator designates a position on a screen according to an input by the player. The game processor performs game processing according to the position on the screen designated by the designator and a state of the virtual camera.

According to the first invention, on the basis of the position on the screen designated by the player and the state of the virtual camera controlled according to the position of the predetermined image as to the player who images the image, the game processing is performed, so that it is possible to efficiently utilize the posture of the player himself or herself in the game.

A second invention is according to the first invention, and the game processor includes a determiner for determining whether or not the position designated by the designator indicates a display position of the predetermined object in the virtual space.

According to the second invention, whether or not the position designated by the player is the display position of the predetermined object is determined, so that it is possible to utilize the determination result in the game processing.

A third invention is according to the second invention, and the determiner further determines whether or not a direction of the virtual camera when the designation is made by the designator is within a predetermined range set with respect to the predetermined object.

According to the third invention, it is merely determined whether or not the direction of the virtual camera is within the predetermined range, making the determination easy.

A fourth invention is according to the third invention, and a plurality of objects are dispersively arranged within the virtual space. When the determiner determines that the direction of the virtual camera at a time when the designation is made by the designator is within the predetermined range, the predetermined object is represented by a combination of the plurality of objects. For example, the predetermined object is an object representing letter, figure, symbol or image (pattern and character), etc. which is formed by a combination or overlap (including connection or composition (unification)) of a plurality of objects.

According to the fourth invention, in a case that the plurality of objects which are dispersively set within the virtual space are imaged by the virtual camera which is set to the predetermined direction, the predetermined object is represented by the plurality object, so that it is possible to offer interest of finding the predetermined object hidden under the virtual space.

A fifth invention is according to the first invention, and the virtual camera controller fixes a gazing point of the virtual camera in the virtual space, and sets the position of the virtual camera by being brought into correspondence with the position specified by the position specifier.

According to the fifth invention, the position of the virtual camera can be set on the basis of the predetermined image, and the direction is merely directed to the gazing point fixed in the virtual space, so that it is possible to set the position and the direction of the virtual camera on the basis of the imaged image.

A sixth invention is according to the fifth invention, and the position specifier specifies a colored area of a predetermined range from the image imaged by the imager, and calculates predetermined coordinates from the position of the area. For example, a skin color region is specified from the imaged image, and whereby the face of the player is specified to calculate the position of the eyes. The virtual camera controller sets the position of the virtual camera by bringing the position of the predetermined coordinates within the image imaged by the imager into correspondence with coordinates within a predetermined plane in the virtual space. For example, according to the position of the eyes of the player, the position of virtual camera is set.

According to the sixth invention, it is possible to set the position of the virtual camera on the basis of the imaged image.

A seventh invention is according to the first inventions, and the displayer has a first displayer a second displayer. The imager is placed between the first displayer and the second displayer. Accordingly, the face of the player turned to the game apparatus is imaged, for example.

In the seventh invention, the imager is placed between the two displayers, so that it is possible to control the virtual camera on the basis of the image of the player who plays the game and views the displayer at the same time.

An eighth invention is according to the first invention, and the game apparatus further includes a direction inputter. The direction inputter inputs a direction according to an input by the player. The designator designates the position on the screen by moving the designation position in the direction input by the direction inputter.

According to the eighth invention, the designation position is moved by the direction inputter, capable of easily designating the position on the screen.

A ninth invention is according to the first invention, and the game apparatus further includes a touch panel on the displayer. The touch panel is placed on the displayer. The designator designates the position on the screen on the basis of an input to the touch panel.

According to the ninth invention, it is only necessary to touch the designation position, capable of easily designating the position on the screen.

A tenth invention is a game program to be executed by a computer of a game apparatus including a displayer for displaying an image and an imager for imaging at least a part of a player, and causes a computer to function as a display controlling means for displaying a virtual space on the displayer; a position specifying means for specifying a position of a predetermined image imaged by the imager; a virtual camera controlling means for controlling a virtual camera according to the position specified by the position specifier; a designating means for designating a position on a screen according to an input by the player; and a game processing means for performing game processing according to the position on the screen designated by the designating means and a state of the virtual camera.

In the tenth invention as well, similar to the first invention, it is possible to efficiently utilize the posture of the player himself or herself in the game.

A fifteenth invention is a game controlling method of a game apparatus having a displayer for displaying an image and an imager for imaging at least a part of a player, including following steps of: (a) displaying a virtual space on the displayer; (b) specifying a position of a predetermined image imaged by the imager; (c) controlling a virtual camera according to the position specified by the step (b); (d) designating a position on a screen according to an input by the player; and (e) performing game processing according to the position on the screen designated by the step (d) and a state of the virtual camera.

In the fifteenth invention as well, similar to the first invention, it is possible to efficiently utilize the posture of the player himself or herself in the game.

The above described objects and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an illustrative view showing one embodiment of an appearance of a game apparatus of the present invention;

FIG. 2 is a top view and a left side view of the game apparatus shown in FIG. 1 which is in a folded state;

FIG. 3 is a block diagram showing an electric configuration of the game apparatus shown in FIG. 1 and FIG. 2;

FIG. 4 is an illustrative view showing an example of use of the game apparatus shown in FIG. 1 and FIG. 2;

FIG. 5 is an illustrative view explaining an angle of field and an imaging range of an inward camera of the game apparatus shown in FIG. 1;

FIG. 6 is an illustrative view explaining an example when a letter or the like is displayed by a plurality of objects in a virtual game of this embodiment;

FIG. 7 is an illustrative view showing one example of a game screen to be displayed on a first LCD and a second LCD which are shown in FIG. 4;

FIG. 8 is an illustrative view showing another example of a game screen to be displayed on the first LCD and the second LCD which are shown in FIG. 4;

FIG. 9 is an illustrative view showing a still another example of a game screen to be displayed on the first LCD and the second LCD which are shown in FIG. 4;

FIG. 10 is an illustrative view showing an example of a relationship among a display surface of the game apparatus shown in FIG. 1, a position of a virtual camera, and a three-dimensional virtual space;

FIG. 11 is an illustrative view showing a relationship between an imaged image shown in FIG. 10 and the display surface;

FIG. 12 is an illustrative view showing another relationship among the display surface of the game apparatus shown in FIG. 1, a position of the virtual camera, a three-dimensional virtual space;

FIG. 13 is an illustrative view showing a relationship between the imaged image shown in FIG. 12 and the display surface;

FIG. 14 is an illustrative view showing an example of an object placed in a three-dimensional virtual space and a hit determining object;

FIG. 15 is a descriptive diagram explaining a correct answer determination when the virtual camera is in a certain position;

FIG. 16 is a descriptive diagram explaining the correct answer determination when the virtual camera is in another position;

FIG. 17 is an illustrative view showing a memory map of a main memory shown in FIG. 3;

FIG. 18 is a flowchart showing an entire processing by a CPU shown in FIG. 3;

FIG. 19 is a flowchart showing eye position acquiring processing by the CPU shown in FIG. 3;

FIG. 20 is a flowchart showing drawing processing by the CPU shown in FIG. 3; and

FIG. 21 is a flowchart showing correct answer determining processing by the CPU shown in FIG. 3.

### DETAILED DESCRIPTION OF THE PREFERRED EMBODIMENTS

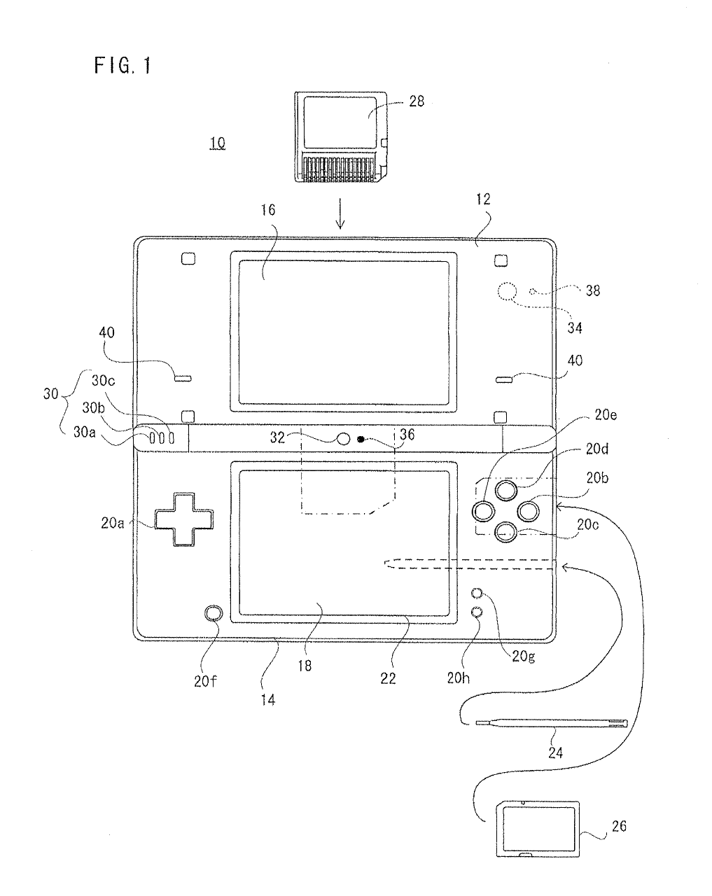

Referring to FIG. 1, a game apparatus 10 of one embodiment of the present invention includes an upper housing 12 and a lower housing 14, and the upper housing 12 and the lower housing 14 are connected with each other so as to be opened or closed (foldable). In FIG. 1 example, the upper housing 12 and the lower housing 14 are constructed in the form of a horizontally long rectangular plate, and are rotatably connected with each other at the long sides of both of the housings. That is, the game apparatus 10 of this embodiment is a folding hand-held game apparatus, and in FIG. 1, the game apparatus 10 is shown in an opened state (in an open state). The game apparatus 10 is constructed such a size that the user can hold with both hands or one hand even in the open state.

Generally, the user uses the game apparatus 10 in the open state. Furthermore, the user keeps the game apparatus 10 in a close state when not using the game apparatus 10. Here, the game apparatus 10 can maintain an opening and closing angle formed between the upper housing 12 and the lower housing 14 at an arbitrary angle between the close state and open state by a friction force, etc. exerted at the connected portion as well as the aforementioned close state and open state. That is, the upper housing 12 can be fixed with respect to the lower housing 14 at an arbitrary angle.

Additionally, the game apparatus 10 is mounted with a camera (32, 34) described later, functioning as an imaging device, such as imaging an image with the camera (32, 34), displaying the imaged image on the screen, and saving the imaged image data.

As shown in FIG. 1, the upper housing 12 is provided with a first LCD 16, and the lower housing 14 is provided with a second LCD 18. The first LCD 16 and the second LCD 18 take a horizontally-long shape, and are arranged such that the directions of the long sides thereof are coincident with the long sides of the upper housing 12 and the lower housing 14. For example, resolutions of the first LCD 16 and the second LCD 18 are set to 256 (horizontal)×192 (vertical) pixels (dots).

In addition, although an LCD is utilized as a display in this embodiment, an EL (Electronic Luminescence) display, a plasmatic display, etc. may be used in place of the LCD. Furthermore, the game apparatus 10 can utilize a display with an arbitrary resolution.

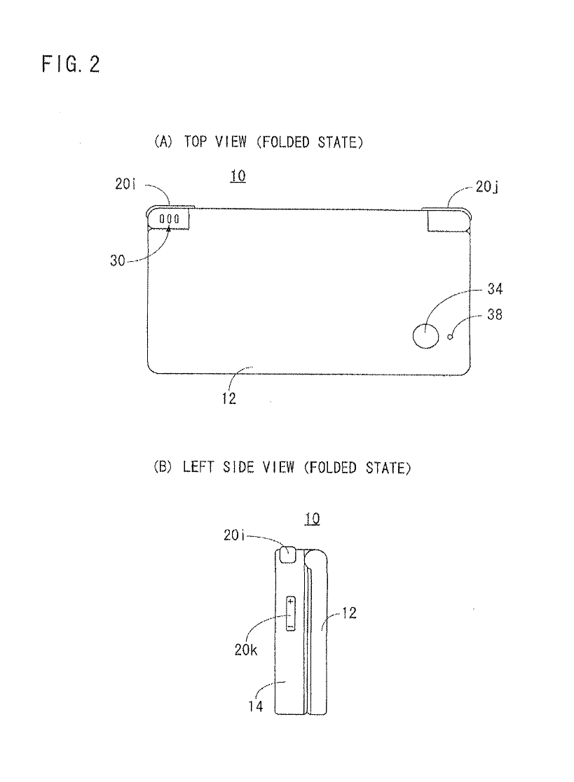

As shown in FIG. 1 and FIG. 2, the lower housing 14 is provided with respective operation buttons 20a-20k as an input device. Out of the respective operation buttons 20a-20k, the direction input button 20a, the operation button 20b, the operation button 20c, the operation button 20d, the operation button 20e, the power button 20f, the start button 20g, and the select button 20h are provided on the surface (inward surface) to which the second LCD 18 of the lower housing 14 is set. More specifically, the direction input button 20a and the power button 20f are arranged at the left of the second LCD 18, and the operation buttons 20b-20e, 20g and 20h are arranged at the right of the second LCD 18. Furthermore, when the upper housing 12 and the lower housing 14 are folded, the operation buttons 20a-20h are enclosed within the game apparatus 10.

The direction input button (cross key) 20a functions as a digital joystick, and is used for instructing a moving direction of a player object, moving a cursor, and so forth. Each operation buttons 20b-20e is a push button, and is used for causing the player object to make an arbitrary action, executing a decision and cancellation, and so forth. The power button 20f is a push button, and is used for turning on or off the main power supply of the game apparatus 10. The start button 20g is a push button, and is used for temporarily stopping (pausing), starting (restarting) a game, and so forth. The select button 20h is a push button, and is used for a game mode selection, a menu selection, etc.

Although operation buttons 20i-20k are omitted in FIG. 1, as shown in FIG. 2 (A), the operation button (L button) 20i is provided at the left corner of the upper side surface of the lower housing 14, and the operation button (R button) 20j is provided at the right corner of the upper side surface of the lower housing 14. Furthermore, as shown in FIG. 2(B), the volume button 20k is provided on the left side surface of the lower housing 14.

FIG. 2(A) is an illustrative view of the game apparatus 10 in a folded manner as seen from a top surface (upper housing 12). FIG. 2(B) is an illustrative view of the game apparatus 10 in a folded manner when seen from a left side surface.

The L button 20i and the R button 20j are push buttons, and can be used for similar operations to those of the operation buttons 20b-20e, and can be used as subsidiary operations of these operation buttons 20b-20e. Furthermore, in this embodiment, the L button 20i and the R button 20j can be also used for an operation of a imaging instruction (shutter operation). The volume button 20k is made up of two push buttons, and is utilized for adjusting the volume of the sound output from two speakers (right speaker and left speaker) not shown. In this embodiment, the volume button 20k is provided with an operating portion including two push portions, and the aforementioned push buttons are provided by being brought into correspondence with the respective push portions. Thus, when the one push portion is pushed, the volume is made high, and when the other push portion is pushed, the volume is made low. For example, when the push portion is hold down, the volume is gradually made high, or the volume is gradually made low.

Returning to FIG. 1, the game apparatus 10 is provided with a touch panel 22 as an input device separate from the operation buttons 20a-20k. The touch panel 22 is attached so as to cover the screen of the second LCD 18. In this embodiment, a touch panel of a resistance film system is used as the touch panel 22, for example. However, the touch panel 22 can employ an arbitrary push-type touch panel without being restricted to the resistance film system. Furthermore, in this embodiment, as the touch panel 22, a touch panel having the same resolution (detection accuracy) as the resolution of the second LCD 18, for example, is utilized. However, the resolution of the touch panel 22 and the resolution of the second LCD 18 are not necessarily coincident with each other.

Additionally, at the right side surface of the lower housing 14, a loading slot (represented by a dashed line shown in FIG. 1) is provided. The loading slot can house a touch pen 24 to be utilized for performing an operation on the touch panel 22. Generally, an input with respect to the touch panel 22 is performed with the touch pen 24, but it may be performed with a finger of the user beyond the touch pen 24. Accordingly, in a case that the touch pen 24 is not to be utilized, the loading slot for the touch pen 24 and the housing portion need not to be provided.

Moreover, on the right side surface of the lower housing 14, a loading slot for housing a memory card 26 (represented by a chain double-dashed line in FIG. 1) is provided. At the inside of the loading slot, a connector (not illustrated) for electrically connecting the game apparatus 10 and the memory card 26 is provided. The memory card 26 is an SD card, for example, and detachably attached to the connector. This memory card 26 is used for storing (saving) an image imaged by the game apparatus 10, and reading the image generated (imaged) or stored by another apparatus in the game apparatus 10.

In addition, on the upper side surface of the lower housing 14, a loading slot (represented by an alternate long and short dash line FIG. 1) for housing a memory card 28 is provided. Inside the loading slot, a connector (not illustrated) for electrically connecting the game apparatus 10 and the memory card 28 is provided. The memory card 28 is a recording medium of recording an information processing program, other necessary data, etc. and is detachably attached to the loading slot provided to the lower housing 14.

At the left end of the connected portion (hinge) between the upper housing 12 and the lower housing 14, an indicator 30 is provided. The indicator 30 is made up of three LEDs 30a, 30b, 30c. Here, the game apparatus 10 can make a wireless communication with another appliance, and the first LED 30a lights up when a wireless communication with the appliance is established. The second LED 30b lights up while the game apparatus 10 is recharged. The third LED 30c lights up when the main power supply of the game apparatus 10 is turned on. Thus, by the indicator 30 (LEDs 30a-30c), it is possible to inform the user of a communication-established state, a charge state, and a main power supply on/off state of the game apparatus 10.

As described above, the upper housing 12 is provided with the first LCD 16. In this embodiment, the touch panel 22 is set so as to cover the second LCD 18, but the touch panel 22 may be set so as to cover the first LCD 16. Alternatively, two touch panels 22 may be set so as to cover the first LCD 16 and the second LCD 18. For example, on the second LCD 18, an operation explanatory screen for teaching the user how the respective operation buttons 20a-20k and the touch panel 22 work or how to operate them, and a game screen are displayed.

Additionally, the upper housing 12 is provided with the two cameras (inward camera 32 and outward camera 34). As shown in FIG. 1, the inward camera 32 is attached in the vicinity of the connected portion between the upper housing 12 and the lower housing 14 and on the surface to which the first LCD 16 is provided such that the display surface of the first LCD 16 and the imaging surface are in parallel with each other or are leveled off. On the other hand, the outward camera 34 is attached to the surface being opposed to the surface to which the inward camera 32 is provided as shown in FIG. 2(A), that is, on the outer surface of the upper housing 12 (the surface turns to the outside when the game apparatus 10 is in a close state, and on the back surface of the upper housing 12 shown in FIG. 1). Here, in FIG. 1, the outward camera 34 is shown by a dashed line.

Accordingly, the inward camera 32 can image a direction to which the inner surface of the upper housing 12 is turned, and the outward camera 34 can image a direction opposite to the imaging direction of the inward camera 32, that is, can image a direction to which the outer surface of the upper housing 12 is turned. Thus, in this embodiment, the two cameras 32, 34 are provided such that the imaging directions of the inward camera 32 and the outward camera 34 are the opposite direction with each other. For example, the user holding the game apparatus 10 can image a landscape (including the user, for example) as the user is seen from the game apparatus 10 with the inward camera 32, and can image a landscape as the direction opposite to the user is seen from the game apparatus 10 with the outward camera 34.

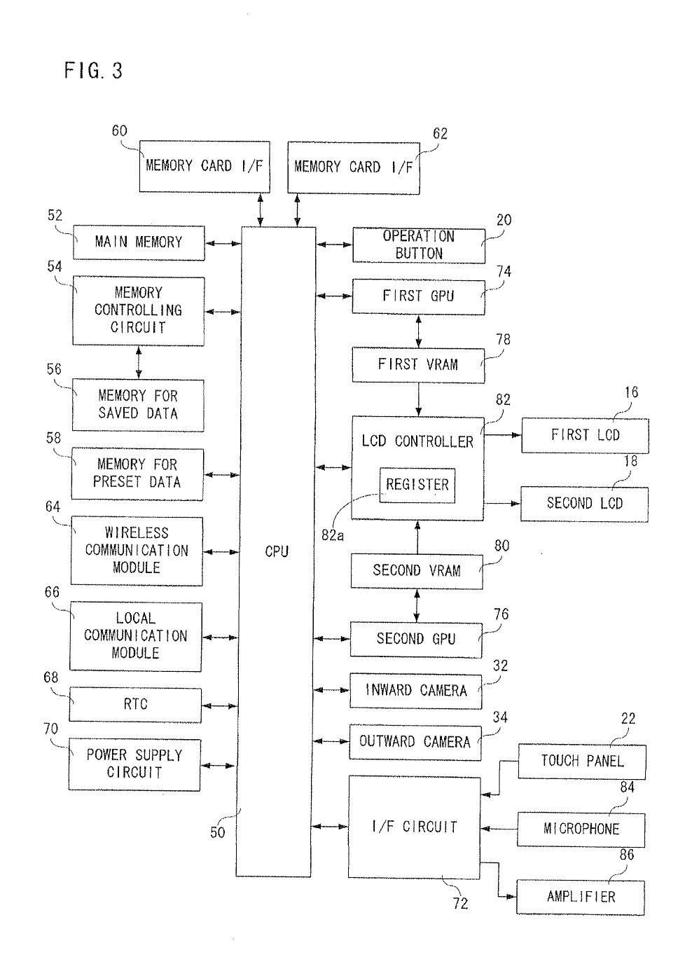

Additionally, on the internal surface near the aforementioned connected portion, a microphone 84 (see FIG. 3) is housed as a voice input device. Then, on the internal surface near the aforementioned connected portion, a through hole 36 for the microphone 84 is formed so as to detect a sound outside the game apparatus 10. The position of housing the microphone 84 and the position of the through hole 36 for the microphone 84 are not necessarily on the aforementioned connected portion, and the microphone 84 may be housed in the lower housing 14, and the through hole 36 for the microphone 84 may be provided to the lower housing 14 in correspondence with the housing position of the microphone 84.

Furthermore, on the outer surface of the upper housing 12, in the vicinity of the outward camera 34, a fourth LED 38 (dashed line in FIG. 1) is attached. The fourth LED 38 lights up at a time when an imaging is made with the inward camera 32 or the outward camera 34 (shutter button is pushed). Furthermore, in a case that a motion image is imaged with the inward camera 32 or the outward camera 34, the fourth LED 38 continues to light up during the imaging. That is, by making the fourth LED 38 light up, it is possible to inform an object to be imaged or his or her surrounding that an imaging with the game apparatus 10 is made (is being made).

Moreover, the upper housing 12 is formed with a sound release hole 40 on both sides of the first LCD 16. The above-described speaker is housed at a position corresponding to the sound release hole 40 inside the upper housing 12. The sound release hole 40 is a through hole for releasing the sound from the speaker to the outside of the game apparatus 10.

As described above, the upper housing 12 is provided with the inward camera 32 and the outward camera 34 which are constituted to image an image and the first LCD 16 as a display means for mainly displaying the imaged image and a game screen. On the other hand, the lower housing 14 is provided with the input device (operation button 20 (20a-20k) and the touch panel 22) for performing an operation input to the game apparatus 10 and the second LCD 18 as a display means for mainly displaying an operation explanatory screen and a game screen. Accordingly, the game apparatus 10 has two screens (16, 18) and two kinds of operating portions (20, 22).

FIG. 3 is a block diagram showing an electric configuration of the game apparatus 10 of this embodiment. As shown in FIG. 3, the game apparatus 10 includes a CPU 50, a main memory 52, a memory controlling circuit 54, a memory for saved data 56, a memory for preset data 58, a memory card interface (memory card I/F) 60, a memory card I/F 62, a wireless communication module 64, a local communication module 66, a real-time clock (RTC) 68, a power supply circuit 70, and an interface circuit (I/F circuit) 72, a first GPU (Graphics Processing Unit) 74, a second GPU 76, a first VRAM (Video RAM) 78, a second VRAM 80, an LCD controller 82, etc. These electronic components (circuit components) are mounted on an electronic circuit board, and housed in the lower housing 14 (or the upper housing 12 may also be appropriate).

The CPU 50 is an information processing means for executing a predetermined program. In this embodiment, the predetermined program is stored in a memory (memory for saved data 56, for example) within the game apparatus 10 and the memory card 26 and/or 28, and the CPU 50 executes information processing described later by executing the predetermined program.

Here, the program to be executed by the CPU 50 may be previously stored in the memory within the game apparatus 10, acquired from the memory card 26 and/or 28, and acquired from another appliance by communicating with this another appliance.

The CPU 50 is connected with the main memory 52, the memory controlling circuit 54, and the memory for preset data 58. The memory controlling circuit 54 is connected with the memory for saved data 56. The main memory 52 is a memory means to be utilized as a work area and a buffer area of the CPU 50. That is, the main memory 52 stores (temporarily stores) various data to be utilized in the aforementioned information processing, and stores a program from the outside (memory cards 26 and 28, and another appliance). In this embodiment, as a main memory 52, a PSRAM (Pseudo-SRAM) is used, for example. The memory for saved data 56 is a memory means for storing (saving) a program to be executed by the CPU 50, data of an image imaged by the inward camera 32 and the outward camera 34, etc. The memory for saved data 56 is constructed by a nonvolatile storage medium, and can utilize a NAND type flash memory, for example. The memory controlling circuit 54 controls reading and writing from and to the memory for saved data 56 according to an instruction from the CPU 50. The memory for preset data 58 is a memory means for storing data (preset data), such as various parameters, etc. which are previously set in the game apparatus 10. As a memory for preset data 58, a flash memory to be connected to the CPU 50 through an SPI (Serial Peripheral Interface) bus can be used.

Both of the memory card I/Fs 60 and 62 are connected to the CPU 50. The memory card I/F 60 performs reading and writing data from and to the memory card 26 attached to the connector according to an instruction form the CPU 50. Furthermore, the memory card I/F 62 performs reading and writing data from and to the memory card 28 attached to the connector according to an instruction form the CPU 50. In this embodiment, image data corresponding to the image imaged by the inward camera 32 and the outward camera 34 and image data received by other devices are written to the memory card 26, and the image data stored in the memory card 26 is read from the memory card 26 and stored in the memory for saved data 56, and sent to other devices. Furthermore, the various programs stored in the memory card 28 is read by the CPU 50 so as to be executed.

Here, the information processing program such as a game program is not only supplied to the game apparatus 10 through the external storage medium, such as a memory card 28, etc. but also is supplied to the game apparatus 10 through a wired or a wireless communication line. In addition, the information processing program may be recorded in advance in a nonvolatile storage device inside the game apparatus 10. Additionally, as an information storage medium for storing the information processing program, an optical disk storage medium, such as a CD-ROM, a DVD or the like may be appropriate beyond the aforementioned nonvolatile storage device.

The wireless communication module 64 has a function of connecting to a wireless LAN according to an IEEE802.11.b/g standard-based system, for example. The local communication module 66 has a function of performing a wireless communication with the same types of the game apparatuses by a predetermined communication system. The wireless communication module 64 and the local communication module 66 are connected to the CPU 50. The CPU 50 can receive and send data over the Internet with other appliances by means of the wireless communication module 64, and can receive and send data with the same types of other game apparatuses by means of the local communication module 66.

Furthermore, the CPU 50 is connected with the RTC 68 and the power supply circuit 70. The RTC 68 counts a time to output the same to the CPU 50. For example, the CPU 50 can calculate a date and a current time, etc. on the basis of the time counted by the RTC 68. The power supply circuit 70 controls power supplied from the power supply (typically, a battery accommodated in the lower housing 14) included in the game apparatus 10, and supplies the power to the respective circuit components within the game apparatus 10.

Also, the game apparatus 10 includes the microphone 84 and an amplifier 86. Both of the microphone 84 and the amplifier 86 are connected to the I/F circuit 72. The microphone 84 detects a voice and a sound (clap and handclap, etc.) of the user produced or generated toward the game apparatus 10, and outputs a sound signal indicating the voice or the sound to the I/F circuit 72. The amplifier 86 amplifies the sound signal applied from the I/F circuit 72, and applies the amplified signal to the speaker (not illustrated). The I/F circuit 72 is connected to the CPU 50.

The touch panel 22 is connected to the I/F circuit 72. The I/F circuit 72 includes a sound controlling circuit for controlling the microphone 84 and the amplifier 86 (speaker), and a touch panel controlling circuit for controlling the touch panel 22. The sound controlling circuit performs an A/D conversion and a D/A conversion on a sound signal, or converts a sound signal into sound data in a predetermined format. The touch panel controlling circuit generates touch position data in a predetermined format on the basis of a signal from the touch panel 22 and outputs the same to the CPU 50. For example, touch position data is data indicating coordinates of a position where an input is performed on an input surface of the touch panel 22.

Additionally, the touch panel controlling circuit performs reading of a signal from the touch panel 22 and generation of the touch position data per each predetermined time. By fetching the touch position data via the I/F circuit 72, the CPU 50 can know the position on the touch panel 22 where the input is made.

The operation button 20 is made up of the aforementioned respective operation buttons 20a-20k, and connected to the CPU 50. The operation data indicating a input state (whether or not to be pushed) with respect to each of the operation buttons 20a-20k is output from the operation button 20 to the CPU 50. The CPU 50 acquires the operation data from the operation button 20, and executes processing according to the acquired operation data.

Both of the inward camera 32 and the outward camera 34 are connected to the CPU 50. The inward camera 32 and the outward camera 34 image images according to an instruction from the CPU 50, and output image data corresponding to the imaged images to the CPU 50. In this embodiment, the CPU 50 issues an imaging instruction to any one of the inward camera 32 and the outward camera 34 while the camera (32, 34) which has received the imaging instruction images an image and sends the image data to the CPU 50.

The first GPU 74 is connected with the first VRAM 78, and the second GPU 76 is connected with the second VRAM 80. The first GPU 74 generates a first display image on the basis of data for generating the display image stored in the main memory 52 according to an instruction from the CPU 50, and draws the same in the first VRAM 78. The second GPU 76 similarly generates a second display image according to an instruction form the CPU 50, and draws the same in the second VRAM 80. The first VRAM 78 and the second VRAM 80 are connected to the LCD controller 82.

The LCD controller 82 includes a register 82a. The register 82a stores a value of “0” or “1” according to an instruction from the CPU 50. In a case that the value of the register 82a is “0”, the LCD controller 82 outputs the first display image drawn in the first VRAM 78 to the second LCD 18, and outputs the second display image drawn in the second VRAM 80 to the first LCD 16. Furthermore, in a case that the value of the register 82a is “1”, the LCD controller 82 outputs the first display image drawn in the first VRAM 78 to the first LCD 16, and outputs the second display image drawn in the second VRAM 80 to the second LCD 18.

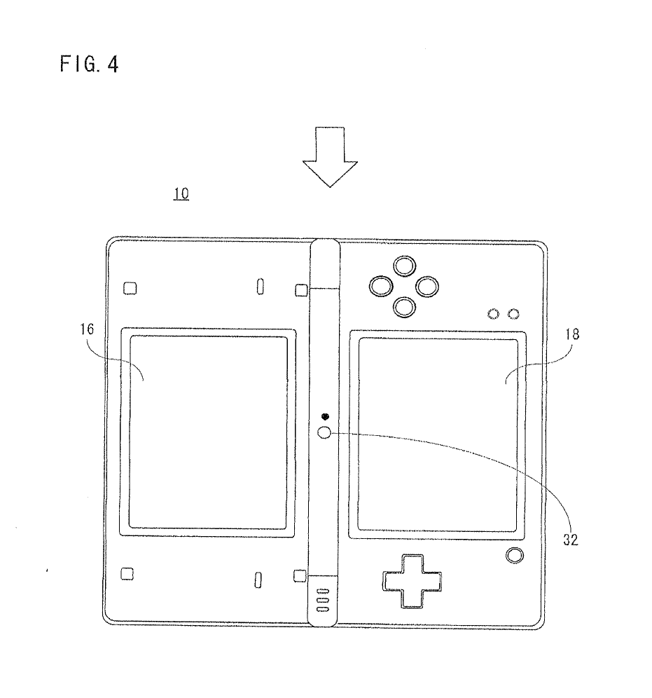

FIG. 4 shows an example of use of the game apparatus 10 in a case that the game processing of this embodiment is executed. As shown in FIG. 4, the game apparatus 10 is held by the use or the player (hereinafter referred to as “player”) in a state it is counterclockwise rotated from a state shown in FIG. 1 by about 90 angles. Accordingly, the first LCD 16 and the second LCD 18 are arranged side by side.

For example, in the virtual game of this embodiment, the eyes of the player are specified from the image (face image) imaged by the inward camera 32, the position of the eyes with respect to the game apparatus 10 (the first LCD 16 and the second LCD 18) is calculated (acquired), and a position of a viewpoint (virtual camera) within the three-dimensional virtual space is controlled in correspondence with the acquired position of the eyes.

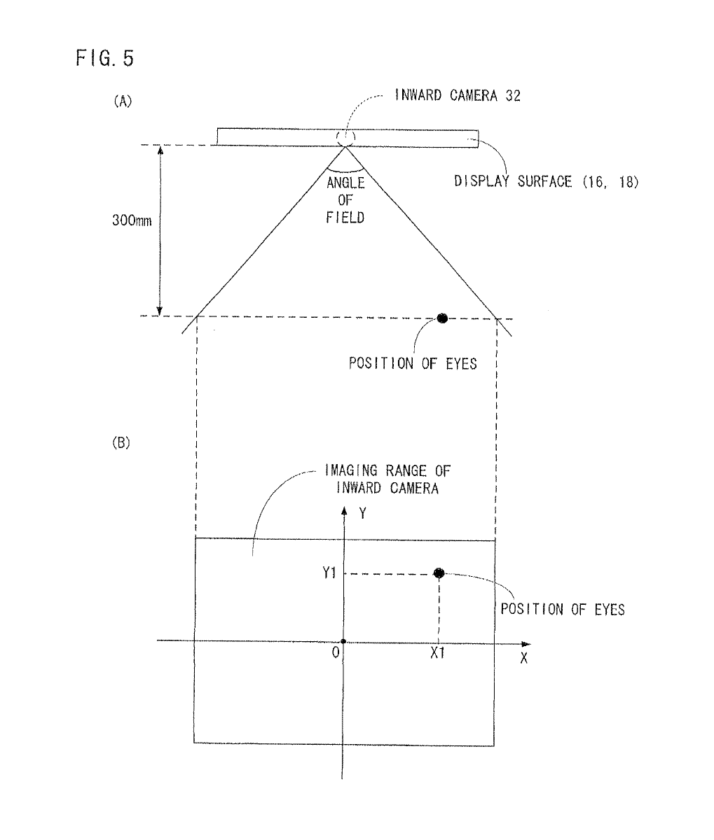

As shown in FIG. 5(A), in a case that the game apparatus 10 is viewed from an arrow direction in FIG. 4, the position of the face (eyes) of the player is assumed to be apart from the display surface of the game apparatus 10 (display surfaces of the first LCD 16 and the second LCD 18) by a fixed distance (300 mm, for example). Furthermore, in such a case, by an angle of field of the inward camera 32, the width (horizontal length in FIG. 5(B)) of an imaging range is decided as shown in FIG. 5(B). Although illustration is omitted, the length of the imaging range (vertical length in FIG. 5(B)) is decided in a similar manner.

Here, eye position acquiring (specifying) processing is explained. First, a skin-color region is extracted from the imaged image by the inward camera 32. In this embodiment, a skin-color region and a non-skin-color region are represented by binarization (binarizing processing). Here, whether the skin-color region or the non-skin-color region is judged for each pixel. For example, as to the pixel of being a skin color, “1” is set, and as to the pixel of not being a skin color, “0” is set.

Although detailed explanation is omitted, prior to the star of a main part of the virtual game, the face image of the player is imaged in advance, and on the basis of the imaged image, the information of the skin color of the player (chrominance (Cr, Cb) value in this embodiment) is acquired. This is because that the skin color is different from one player to another player, and even the same player, the skin color is different depending on the environment in which the virtual game is played (dark place and light place, for example). Furthermore, the range of the color-difference values which is determined as a skin color is calibrated separately. As one example, the Cr (red of the color-difference component) can take a value selected from 135 to 144 (where 144 is a peak value and 135≦Cr≦153 is established), and the Cb (blue of the color-difference component) can take a value selected from 109 to 129 (where 119 is a peak and 109≦Cb≦129 is established). For example, the peak value is decided by a mode value at a time of the calibration, and with respect to the range around the peak, the value corresponding to the frequency one-sixty-fourth of the frequency at the peak can be taken.

When the skin color is extracted from the imaged image, and binaraization processing is performed, block information as to the skin color is generated. Here, the information about an area (range) where a predetermined number or more pixels which are determined to be a skin color are present in a block (block information) is generated. Next, out of the entire block information, one piece of block information representing the largest block (range) is selected. This is because that the largest block corresponds to the face.

Here, a predetermined number for judging whether the block or not is decided depending on the resolution (the number of pixels) of the imaged image.

Succeedingly, the torso part is deleted from the selected block information. That is, in a case that the imaged image is searched from top to bottom, the information corresponding to the part below which the width abruptly expands is deleted in the selected block information. That is, the skin-color region below the position corresponding to the shoulder is deleted. Thus, the skin color region corresponding to the part of the face is left.

Then, the uppermost position and the lowermost position of the skin color region corresponding to the part of the face are acquired. That is, the uppermost position of the forehead or the position corresponding to the parietal region and the position corresponding to the chip end of the jaw are acquired. From the two positions, the position of the eyes is specified. The position below the uppermost position of the forehead or the position corresponding to the parietal region by a certain value is set as a position of the eyes. In this embodiment, the position located below the uppermost position by the length eighth part of the length between the uppermost position and the lowermost position is specified as the position of the eyes. This is a value empirically obtained by experiments, and the like. Thus, the position of the eyes in a height direction is decided from the imaged image. Furthermore, in this embodiment, the position of the eyes in a lateral direction is decided to be the position the same as the uppermost position. Here, the position of the eyes in the lateral direction may be decided on the basis of the uppermost position and the lowermost position. For example, the position of the eyes in the lateral direction is decided between the midpoint between the uppermost position and the lowermost position.

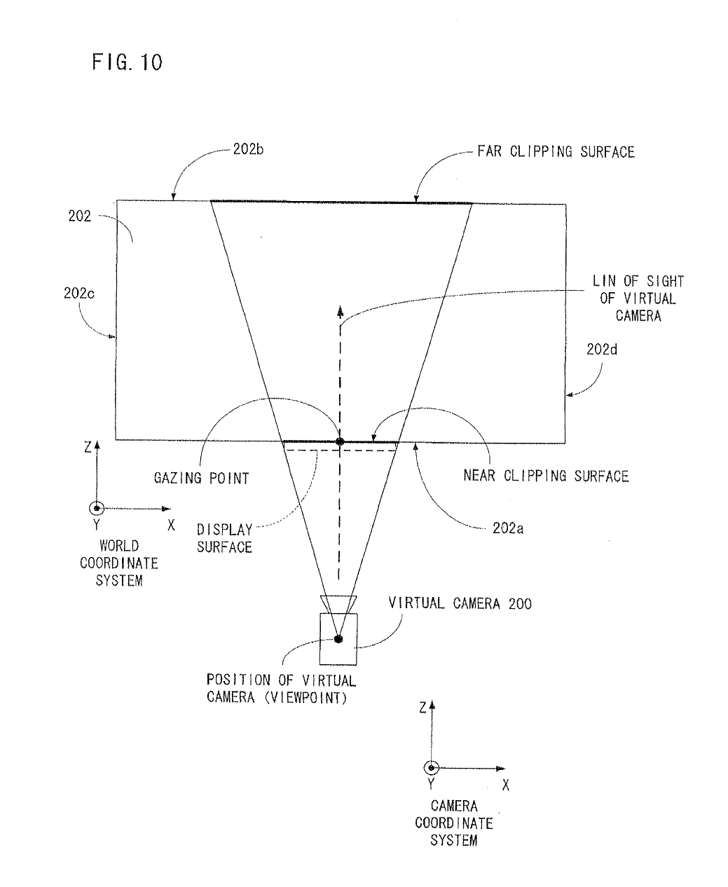

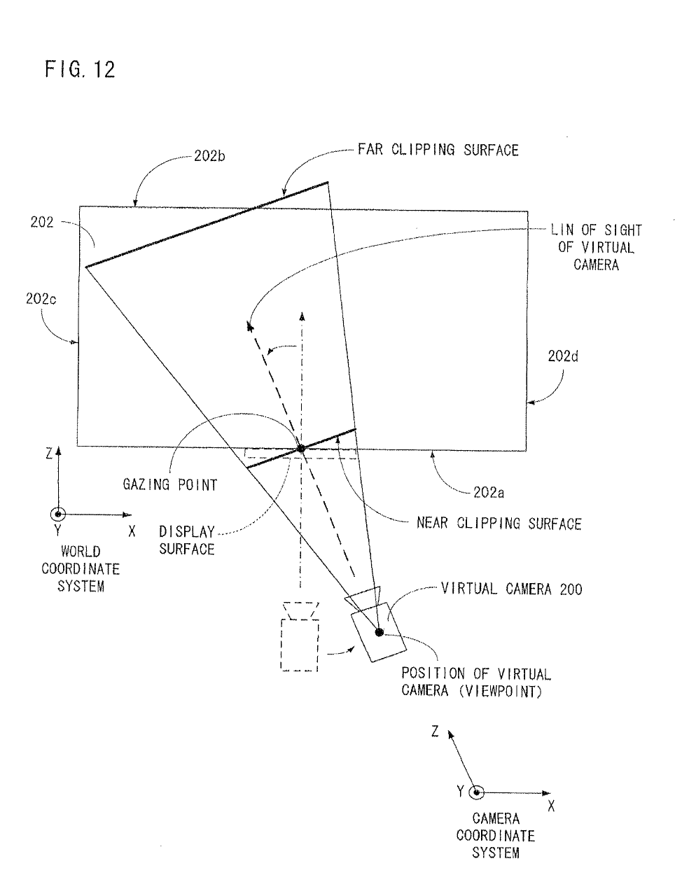

When the position of the eyes is specified from the imaged image, two-dimensional coordinates (X1,Y1) of the position of the eyes in a two-dimensional imaging range with the center of the imaged image by the inward camera 32 as an origin point O as shown in FIG. 5(B) are decided. For example, the size of the imaged image by the inward camera 32 corresponds to the range within which the virtual camera 200 is movable, and in correspondence with the two-dimensional coordinates of the position of the eyes, the position of the virtual camera 200 within an X-Y plane (see FIG. 10 and FIG. 12) in a three-dimensional virtual space is decided. Here, a Z coordinate of the virtual camera 200 in the three-dimensional virtual space is decided such that the virtual camera 200 is moved within the X-Y plane with the distance to a gazing point described later constant. Here, the distance between the virtual camera 200 and the gazing point is set to a length corresponding to a constant distance (300 mm in this embodiment) in a real space. Alternatively, the virtual camera 200 may be moved in an X-Y plane being in parallel with the gazing point plane at a distance corresponding to the constant distance (300 mm, for example) from the surface including the gazing point (gazing point plane) apart. In such a case, the Z coordinate of the virtual camera 200 in the three-dimensional virtual space becomes a constant value.

Furthermore, in the three-dimensional virtual space, the position of the gazing point is fixedly decided, and thus, by changing the position of the virtual camera 200, images obtained by viewing the three-dimensional virtual space in various directions are displayed on the first LCD 16 and the second LCD 18 as game screens. Here, as described later, in this embodiment, the camera matrix is set such that the three-dimensional virtual space (range in which a plurality of objects are arranged) is viewed so as to be fixedly set with respect to the display surfaces of the first LCD 16 and the second LCD 18.

Furthermore, in the virtual game of this embodiment, by changing the position of the virtual camera 200, a certain letter (hiragana, katakana, kanji, Roman letters (alphabet), numerics (Arabic numerals) etc.), a certain design, a certain symbol, a certain pattern (including images of certain characters), etc. (hereinafter referred to as “letter or the like” if all of them are included) are represented by combination and overlap (connection, composite or unification) of the plurality of objects and the shapes and the designs of the plurality of objects (designs added to the object and designs drawn in the background) which are displayed on the game screen 100.

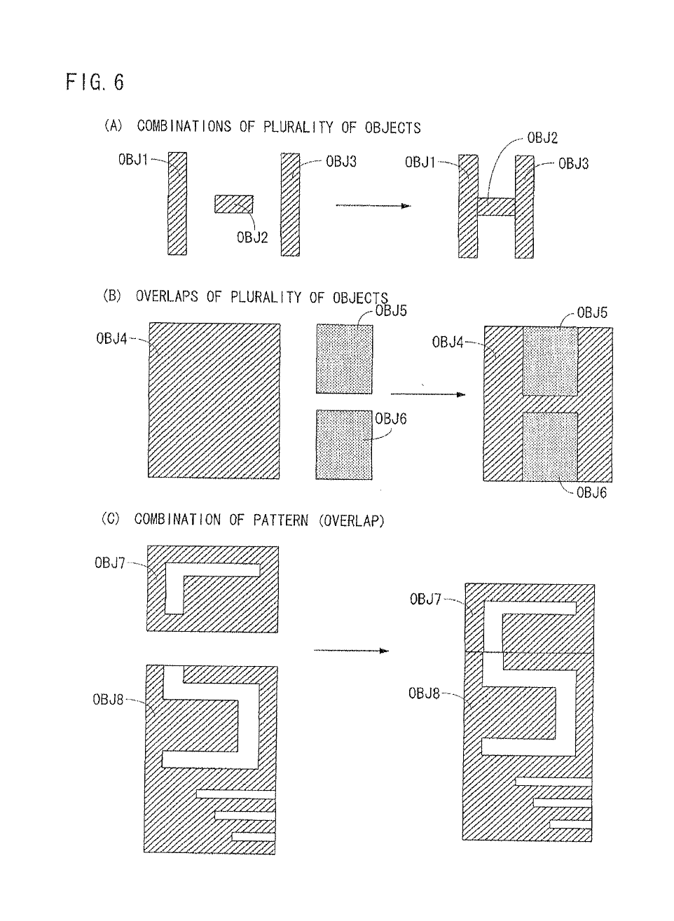

For example, as shown in FIG. 6(A), in a case that three separate objects OBJ1, OBJ2, OBJ3 are displayed on the game screen, by moving the position of the virtual camera 200 to the left or the right, through combinations of the three objects OBJ1-OBJ3, the letter of “H” of the alphabet can be visually perceived. That is, an object indicating the letter of “H” of the alphabet appears. Assuming that in FIG. 6(A), on the left side of the arrow, the virtual camera 200 is placed in front of the objects OBJ1-OBJ3, and the gazing point is fixed as described above. This can be applied to FIG. 6(B) and FIG. 6(C).

Furthermore, as shown in FIG. 6(B), in a case that three separate objects OBJ4, OBJ5, OBJ6 are displayed on the game screen, by moving the virtual camera 200 to the right direction, the object OBJ5 and the object OBJ6 are overlapped with the front surface of the object OBJ4 to hide the part of the object OBJ4 under the object OBJ5 and the object OBJ6, for example. Thus, the object indicating the letter of “H” of the alphabet can be visually perceived. That is, the object indicating the letter of “H” of the alphabet appears.

In addition, as shown in FIG. 6(C), in a case that two separate object OBJ7 and object OBJ8 are displayed on the game screen, when the virtual camera 200 is moved upward or downward, the designs drawn on the object OBJ7 and the object OBJ8 are combined (connected) to allow the user to visually perceive the letter of “5” of the numeric. That is, the object having a design showing the letter of “5” of the numeric appears.

Although illustration is omitted, a plurality of designs which are drawn in each of a plurality of objects (including the background object) may be overlapped or combined with each other to represent a letter or the like.

Moreover, although illustration is omitted, by utilizing two or more processing explained by utilizing FIG. 6(A)-(C), a letter or the like may be represented.

Additionally, in FIG. 6(A)-(C), the planar objects OBJ1-OBJ8 are merely combined or overlapped as it is for simplicity, but in reality, an image obtained by imaging the three-dimensional virtual space with the virtual camera 200 is displayed as a game screen. That is, when the virtual camera 200 is set so as to view the object from any one of the right and left directions, the width of the object looks narrow. Alternatively, when the virtual camera 200 is set so as to view the object from any one of the upward and downward directions, the length of the object looks short. Moreover, with respect to the three-dimensional object, when it is viewed from the front, it looks like a planar object, but when the virtual camera 200 is set to view it from the left, right, top, bottom or oblique direction, the thickness (side surface) of the object can be viewed.

In the virtual game, a plurality of certain letters are offered to the player as questions. The player controls the position of the virtual camera 200 by changing the posture or the position of the player himself or herself, and the orientation or the position of the game apparatus 10 with respect to the player himself or herself. As described above, in this embodiment, the position of the virtual camera 200 is controlled to the position of the eyes specified from the face image, so that the player changes the position of the face (head) with respect to the game apparatus 10 (the first LCD 16 and the second LCD 18). In response thereto, the game screen 100 is changed. That is, by controlling the virtual camera 200, a direction in which the three-dimensional virtual space is viewed is changed. Thus, a predetermined letter or the like as a question is found (searched). Then, when all the predetermined letters or the like as questions are found, the game is to be cleared.

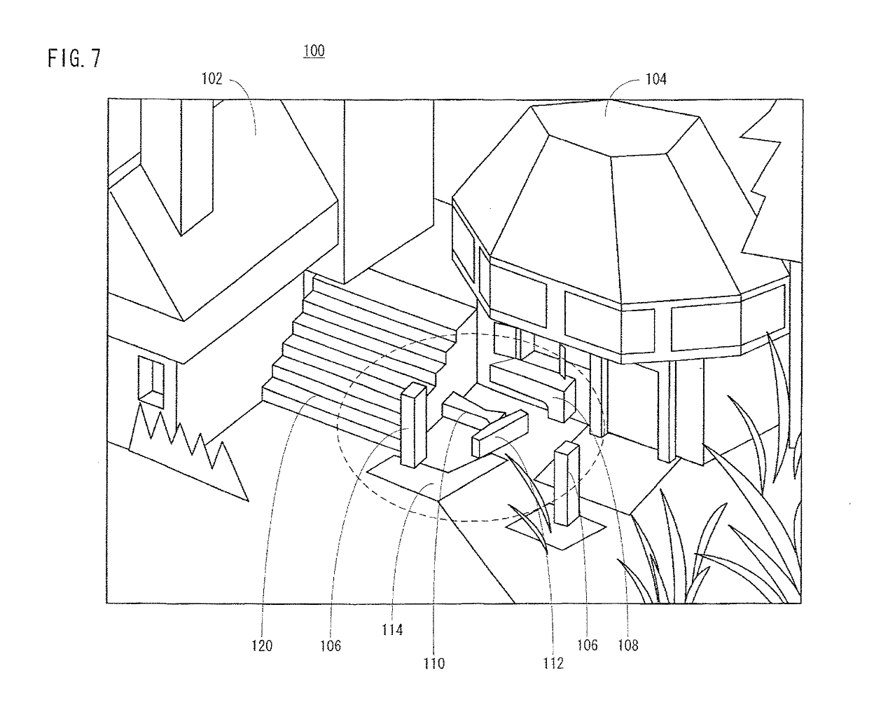

FIG. 7 shows an example of the game screen 100 to be displayed on the first LCD 16 and the second LCD 18 of the game apparatus 10 in a state shown in FIG. 4. Here, in FIG. 7, in order to clearly show a range to be noted (range circled by dotted line) in the three-dimensional virtual space (range in which a plurality of objects are arranged), the display surface of the first LCD 16 and the display surface of the second LCD 18 are shown without being separated. Furthermore, FIG. 7 shows the game screen 100 when the range in which the plurality of objects are arranged in the three-dimensional virtual space is viewed from an obliquely upper right direction is displayed. That is, the virtual camera 200 is placed at the obliquely upper right position with respect to the gazing point in the X-Y plane of the three-dimensional virtual space.

As shown in FIG. 7, an object 102 and an object 104 which imitate houses are displayed on the game screen 100. Furthermore, just before the object 104, two objects 106 corresponding to a gate are displayed. In addition, an object 108 constructing a part of a bay window of the object 104 is displayed. In addition, an object 110 and an object 112 like a chair or a table are displayed between the left object 106 and the object 108. In addition, in the vicinity of the left object 106, an object 114 for paving a part of the ground is displayed. Furthermore, an object 120 imitating a step is displayed between the object 102 and the object 104.

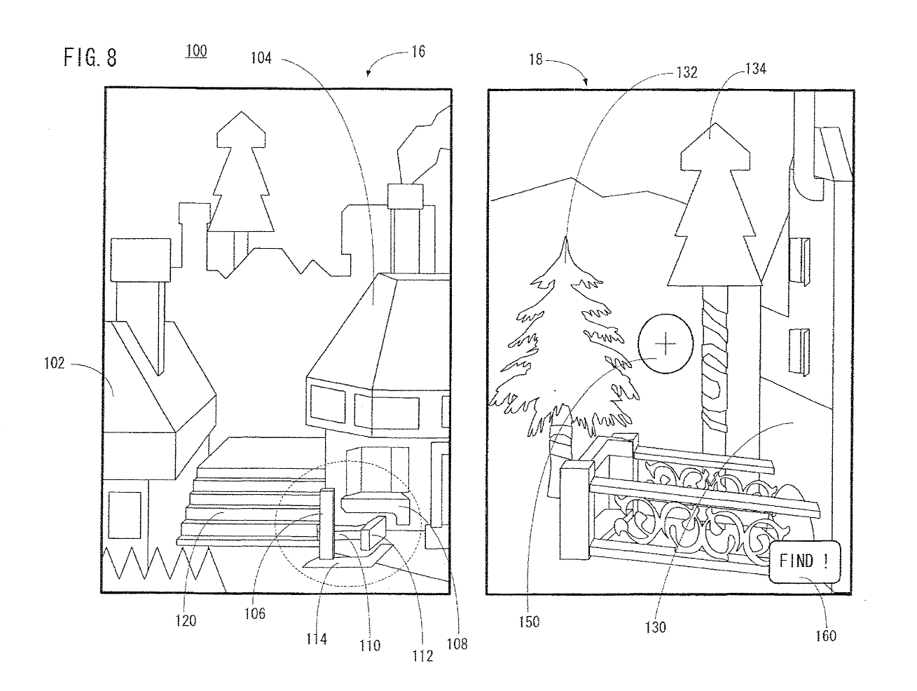

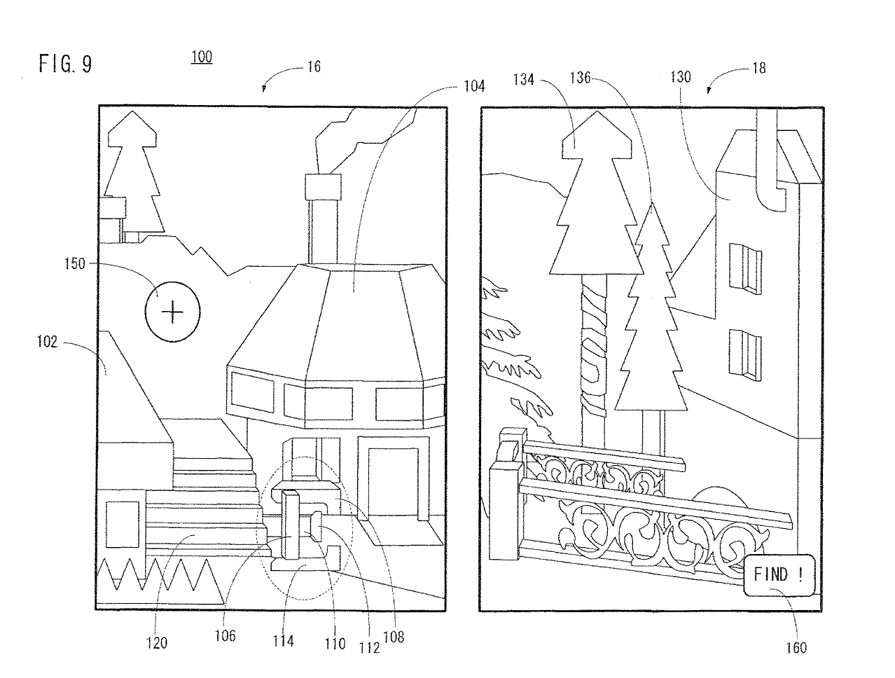

Additionally, in FIG. 7, although reference numerals are not given, other objects and background objects corresponding to grass and a tree are also displayed on the game screen 100. Furthermore, although omitted in FIG. 7 (this can be applied to FIG. 8 and FIG. 9 described later) for simplicity, a moving image object, such as a person, a vehicle, etc. may be displayed.

In FIG. 8, a game screen 100 when the range in which the plurality of objects are arranged in the three-dimensional virtual space of this embodiment is viewed from the front or approximately the front is displayed on the first LCD 16 and the second LCD 18. That is, the virtual camera 200 is placed at a position right in front of or in the vicinity thereof with respect to the gazing point within the X-Y plane in three-dimensional virtual space. On the game screen 100 shown in FIG. 8, on the right hand of the object 104, that is, on the right screen (screen on the second LCD 18), an object 130 imitating a house is displayed. Furthermore, between the object 130 and the object 104, objects 132 and 134 imitating trees are displayed.

Additionally, on the game screen 100 shown in FIG. 8 (this is true for FIG. 9), a designation image 150 like a cursor which is omitted in FIG. 7 is displayed, and a button image 160 is displayed at the lower right of the right screen of the game screen 100.

The designation image 150 is moved to the left, right, top, bottom or oblique direction on the game screen 100 according to an instruction from the player. In this embodiment, when the direction input button 20a is operated, the designation image 150 is moved on the game screen 100 in response to an input operation.

Here, the touch panel 22 is provided on the second LCD 18, thus, as to right screen in the game screen 100 which is displayed on the second LCD 18, the designation image 150 may be moved according to a touch input. Furthermore, if a touch panel is provided on the first LCD 16 as well, the designation image 150 can be moved by a touch input on the entire game screen 100.

The button image 160 is provided for inputting a designated determination as to whether a correct answer or not. In this embodiment, when a touch is made on the button image 160 to turn the button image 160 on, it is determined whether or not a letter or the like the same as the letter or the like as a question is represented (displayed) at the position designated by the designation image 150. That is, whether a correct answer or not is determined. This determination method is explained later in detail.

It should be noted that in this embodiment, when the button image 160 is turned on, a touch is made on the button image 160, but according to a button operation (turning-on the A button 20b, for example), the button image 160 may be turned on.

Here, in this embodiment, the designation image 150 and the button image 160 are drawn on the projection plane.

In FIG. 9, a game screen 100 when the range in which the plurality of objects are arranged in the three-dimensional virtual space of this embodiment is viewed from a slight left direction of the front is displayed on the first LCD 16 and the second LCD 18. That is, the virtual camera 200 is placed at a position slightly left from the right front with respect to the gazing point within the X-Y plane in the three-dimensional virtual space. In FIG. 9, by the plurality of objects 106, 108, 110, 112, 114 which are arranged in a range to be noted (range encircled by dotted frame), a certain letter (the letter of “E” of the alphabet appears, here) is represented. That is, as shown in FIG. 7 and FIG. 8, by combinations of the objects 106-114 which are dispersively arranged, one object representing a certain letter is shown on the game screen 100 shown in FIG. 9. Moreover, as shown in FIG. 7-FIG. 9, within the range to be noted, the letter or the like is shown or is not shown in correspondence with the angle at which the player views the objects.

For example, when the player operates the direction input button 20a to move the designation image 150 to the certain letter (“E”, here), and turns the button image 160 on in the state shown in FIG. 9, it is determined whether not the letter or the like as a correct answer is represented by the object designated by the designation image 150 (object constructed by the objects 106-114, here). Although illustration is omitted, the above-described plurality of letter or the like as questions are translucently displayed on the upper portion of the game screen 100, and whereby, the player can know the letters or the like as the questions, and searches a letter or the like the same as the letter or the like as the question by changing the position of the virtual camera 200.

Furthermore, as described above, if the button image 160 is turned on by the player, and the letter or the like represented by the object designated by the designation image 150 is coincident with (matches with) the letter or the like as the question, this is determined to be the correct answer. As to the letter or the like which is correctly answered, predetermined color and pattern are given to the letter or the like as the question which is translucently displayed, for example.

Here, by utilizing FIG. 10-FIG. 13, a method of changing the display of the game screen 100 in correspondence with the position of the virtual camera 200 (viewpoint) during playing of the virtual game is explained. Here, in FIG. 10-FIG. 13, the explanation is made assuming that there is no movement of the virtual camera 200 (viewpoint) in a Y-axis direction (up and down direction) within the X-Y plane. That is, the upward and downward position of the virtual camera 200 is set to the position the same as that of the gazing point.

FIG. 10 is an illustrative view when a range 202 in which a plurality of objects (102-114,120, 130-136, etc.) are arranged in the three-dimensional virtual space is viewed from directly above. Here, in FIG. 10 (this is true for FIG. 12), the objects (102-114, 120, 130-136, etc.) are omitted for simplicity. For example, in a coordinate system of the three-dimensional virtual space (world coordinate system), a right and left direction with respect to the page is an X-axis direction, a vertical direction with respect to the page is a Y-axis direction, and an up and down direction with respect to the page is a Z-axis direction, as shown in FIG. 10. Furthermore, the right direction is the plus direction of the X-axis, and the vertical upwards direction is the plus direction of the Y-axis, and the upward direction is the plus direction of the Z-axis.

Moreover, although it is difficult to understand in FIG. 10, the range 202 is defined by a rectangular parallelepiped, for example. In this embodiment, the X-Y plane nearest the virtual camera 200 in the range 202 is referred to as a front surface 202a. For example, the gazing point is fixedly set at a predetermined position (the center in this embodiment) of the front surface 202a. Furthermore, an X-Y plane which is in parallel with the front surface 202a and is the furthest from the virtual camera 200 in the range 202 is referred to as a back surface 202b. In addition, in the range 202, a Y-Z plane which connects the front surface 202a and the back surface 202b, and can be viewed on the left hand when seen from the virtual camera 200 is referred to as a left side surface 202c, and a Y-Z plane which can be viewed on the right hand when seen from the virtual camera 200 is referred to as a right side surface 202d. Although illustration is omitted, in the range 202, a X-Z plane which connects the front surface and the back surface and can be viewed at the bottom side when seen from the virtual camera 200 is referred to as a bottom surface, and an X-Z plane which can be seen on the top side when seen from the virtual camera 200 is referred to as a top surface. This can be true for FIG. 12.

As shown in FIG. 10, if the virtual camera 200 (viewpoint) is arranged at a position at the center in the right and left direction with respect to the range 202, and right in front of the gazing point (hereinafter to be referred as “frontal position”), a near clipping plane is decided in such a position as to include the gazing point and to be overlapped with the front surface 202a. Here, the size of the near clipping plane (this is true for a far clipping plane described later) is decided by a view angle of the virtual camera 200. Furthermore, the far clipping plane is decided in such a position as to be overlapped with the back surface 202b. It should be noted that as can be understood from FIG. 10, the distance between the virtual camera 200 and the far clipping plane is longer than the distance between the virtual camera 200 and the near clipping plane.

Furthermore, in this embodiment, as shown in FIG. 10, the display surfaces of the first LCD 16 and the second LCD 18 shall be fixedly arranged in such a position as to be in contact with the range 202 in the three-dimensional virtual space and be in coincident with the near clipping plane when the virtual camera 200 is set in the frontal position.

Additionally, as shown in FIG. 10, in a case that the virtual camera 200 is placed at the frontal position, the world coordinate system and a camera coordinate system are coincident with each other. At this time, the right direction of the display surfaces of the first LCD 16 and the second LCD 18 and a plus direction of the X-axis of the camera coordinate system are coincident with each other, and the upward direction of the display surface and a plus direction of the Y-axis of the camera coordinate system are coincident with each other. Here, in the camera coordinate system, the right and left direction of the virtual camera 200 is the X-axis direction, the up and down direction of the virtual camera 200 (direction vertical to the page) is the Y-axis direction, and the forward and backward direction (up and down direction of the page) of the virtual camera 200 is the Z-axis direction. Furthermore, the right direction of the virtual camera 200 is the plus direction of the X-axis, the upward direction of the virtual camera 200 (direction vertical to the page) is the plus direction of the Y-axis, and the forward direction (upward direction of the page) of the virtual camera 200 is the plus direction of the Z-axis.

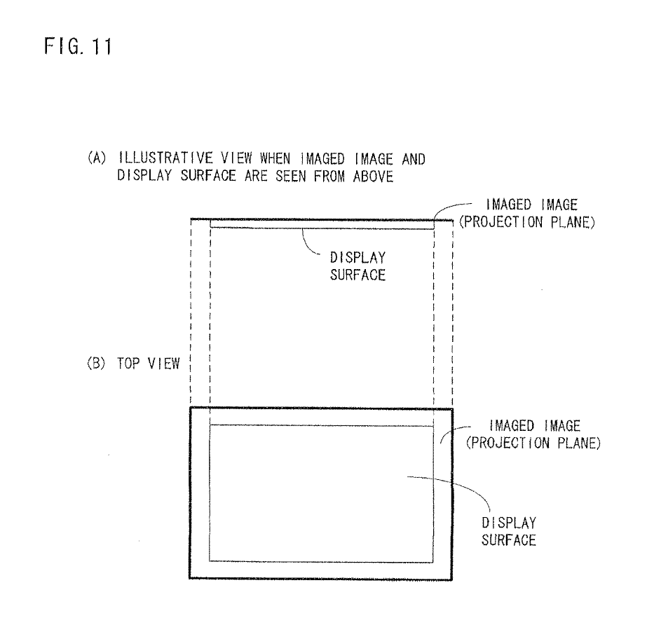

In such a case, as well understood from FIG. 11(A) and FIG. 11(B), the near clipping plane and the display surfaces of the first LCD 16 and the second LCD 18 are parallel with each other. Furthermore, although illustration is omitted, in this embodiment, the projection plane (virtual screen) when perspective projection transforming processing is performed is set to the position the same as that of the near clipping plane.

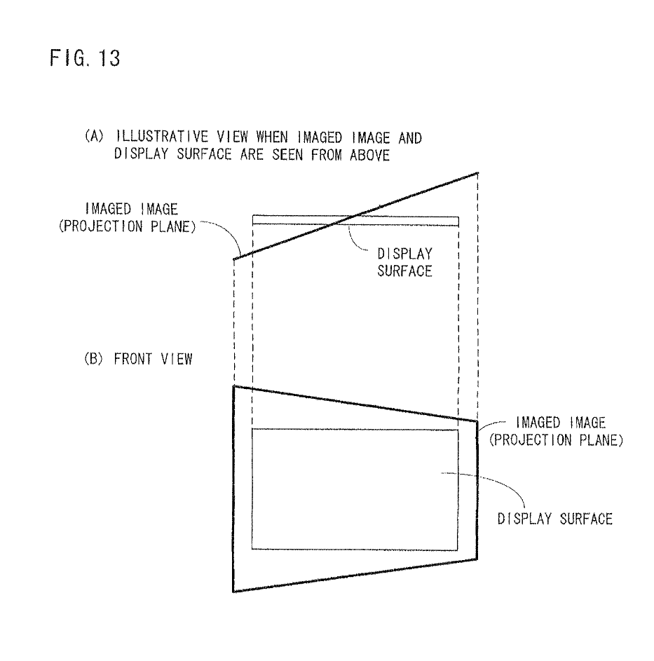

It should be noted that in FIG. 11(A) and FIG. 11(B), in order to clearly show the size of the imaged image and the size of the display surface, the size of the imaged image is larger than that of the display surface, but in reality, these sizes are the same or approximately the same. This is true for cases shown in FIG. 13(A) and FIG. 13(B).

Accordingly, in such a case, by utilizing the normal camera matrix A shown in Equation 1, the three-dimensional coordinates of the three-dimensional virtual space which is seen from the virtual camera 200 are transformed into the camera coordinates, and even if normal perspective projection transforming processing is performed, the three-dimensional virtual space (range 202) can be viewed so as to be fixedly provided with respect to the display surfaces of the first LCD 16 and the second LCD 18 on the game screen 100 displayed on the first LCD 16 and the second LCD 18.

$$A = [ \begin{matrix}Xx & Xy & Xz & - Px * Xx - Py * Xy - Pz * Xz \\ Yx & Yy & Yz & - Px * Yx - Py * Yy - Pz * Yz \\ Zx & Zy & Zz & - Px * Zx - Py * Zy - Pz * Zz\end{matrix} ] \qquad [ Equation 1 ]$$

Here, the (Px, Py, Pz) is a coordinate of the position where the virtual camera 200 is placed in the three-dimensional virtual space. Furthermore, the (Xx, Xy, Xz) is a unit vector in the three-dimensional virtual space in which the right direction of the virtual camera 200 is oriented. In addition, the (Yx, Yy, Yz) is a unit vector in the three-dimensional virtual space in which the upward direction of the virtual camera 200 is oriented. In addition, the (Zx, Zy, Zz) is a unit vector in the three-dimensional virtual space oriented from the gazing point to the virtual camera 200.

However, as shown in FIG. 12, in a case that the virtual camera 200 is moved to the right direction in the three-dimensional virtual space, the near clipping plane (projection plane) is slanted with respect to the display surfaces of the first LCD 16 and the second LCD 18. In such a case, when the camera matrix A according to the Equation 1 is utilized, and the normal perspective projection transforming processing is performed, the game screen 100 which is displayed on the first LCD 16 and the second LCD 18 is not displayed such that the three-dimensional virtual space (range 202) is fixedly provided with respect to the display surfaces of the first LCD 16 and the second LCD 18. That is, the virtual camera 200 is placed obliquely with respect to the three-dimensional virtual space (range 202), but on the display surfaces of the first LCD 16 and the second LCD 18, the image of the three-dimensional virtual space viewed when the virtual camera 200 is placed in front is merely displayed.

Accordingly, in this embodiment, in order to display the game screen 100 such that the three-dimensional virtual space (range 202) is fixed with respect to the display surfaces of the first LCD 16 and the second LCD 18, a camera matrix (referred to as a “camera matrix A′” for the sake of convenience of description) is set in which the plus direction of the X-axis of the camera coordinate system is coincident with the right direction of the display surface, and the plus direction of the Y-axis of the camera coordinate system is coincident with the upward direction of the display surface as shown in the lower right of FIG. 12. More specifically, the camera matrix A′ is an inverse matrix of a matrix B shown in Equation 2.

$$B = [ \begin{matrix}vRight . x & vUp . x & vDir . x & vPos . x \\ vRight . y & vUp . y & vDir . y & vPos . y \\ vRight . z & vUp . z & vDir . z & vPos . z \\ 0 & 0 & 0 & 1\end{matrix} ] \qquad [ Equation 2 ]$$

Here, in the Equation 2, vRight is a unit vector (1, 0, 0) in the right direction of the display surfaces of the first LCD 16 and the second LCD 18, vUp is a unit vector (0, 1, 0) in the upward direction of the display surface, and vDir is coordinates obtained by subtracting the coordinates (0, 0, 0) of the gazing point from the coordinates of the virtual camera 200 (position vector vPos), that is, a line of sight vector with respect to the virtual camera 200. Furthermore, each letter of x, y, z after dots of each variable means a component of each vector.

Accordingly, as shown in FIG. 12, even if the virtual camera 200 is moved to the right direction, the X axis and the Y axis of the camera coordinate system are in a fixed state, and only the direction (Z axis) of the gazing point when seen from the virtual camera 200 is changed. In such a case, as shown in FIG. 13(A) and FIG. 13(B), an image imaged by the virtual camera 200 from the obliquely right direction is displayed on the display surfaces of the first LCD 16 and the second LCD 18 which is fixedly arranged with respect to the three-dimensional virtual space (range 202).

Here, in FIG. 13(B), in order to clearly show the depth of the imaging range, the imaging range is shown by a trapezoid, but the imaged image viewed from the front of the virtual camera 200 is a rectangle similar to FIG. 11(B).

Since the camera matrix A′ is thus set, even if the normal perspective projection transforming processing is executed, the game screen 100 is displayed on the first LCD 16 and the second LCD 18 such that the three-dimensional virtual space (range 202) is fixed with respect to the display surfaces of the first LCD 16 and the second LCD 18 as shown in FIG. 7-FIG. 9.

Although illustration is omitted, this can be applied to when the virtual camera 200 is moved in the up and down direction (Y-axis direction of the three-dimensional virtual space) and in the oblique direction (X-axis and Y-axis directions of the three-dimensional virtual space). That is, depending on the position of the virtual camera 200, the direction in which the Z axis of the camera coordinates is directed (vDir.x, vDir.y, vDir.z) is decided and reflected on the game screen 100.

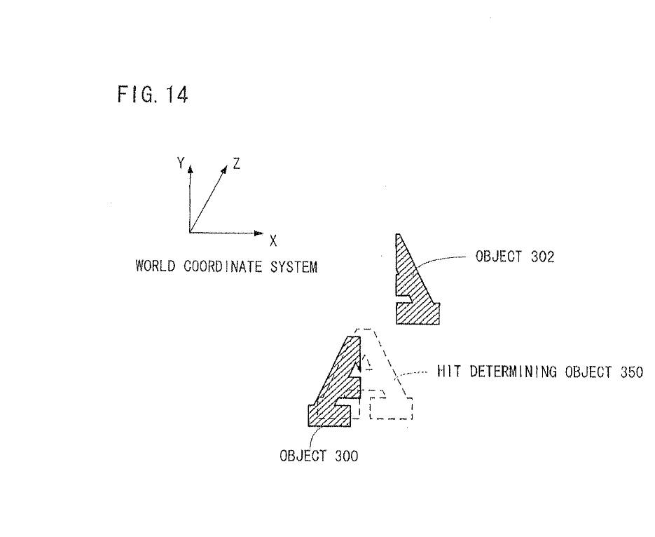

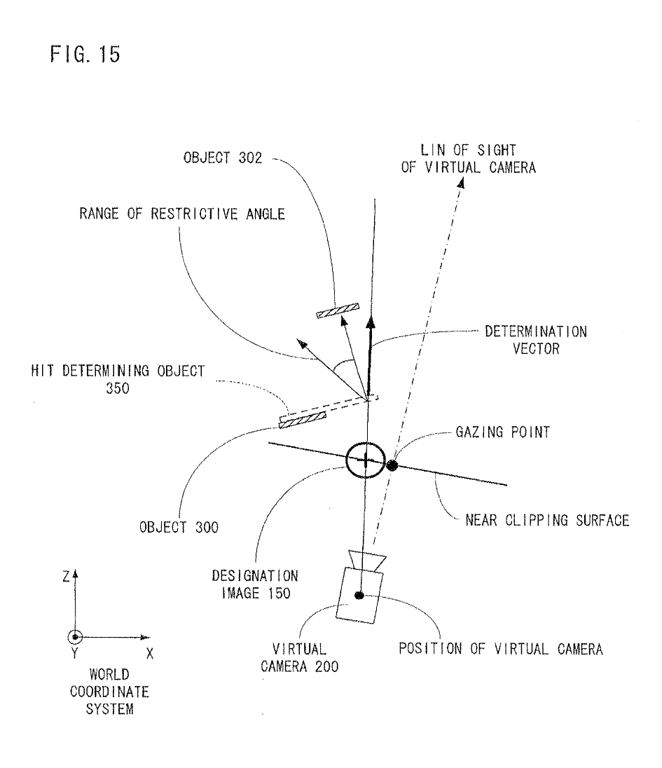

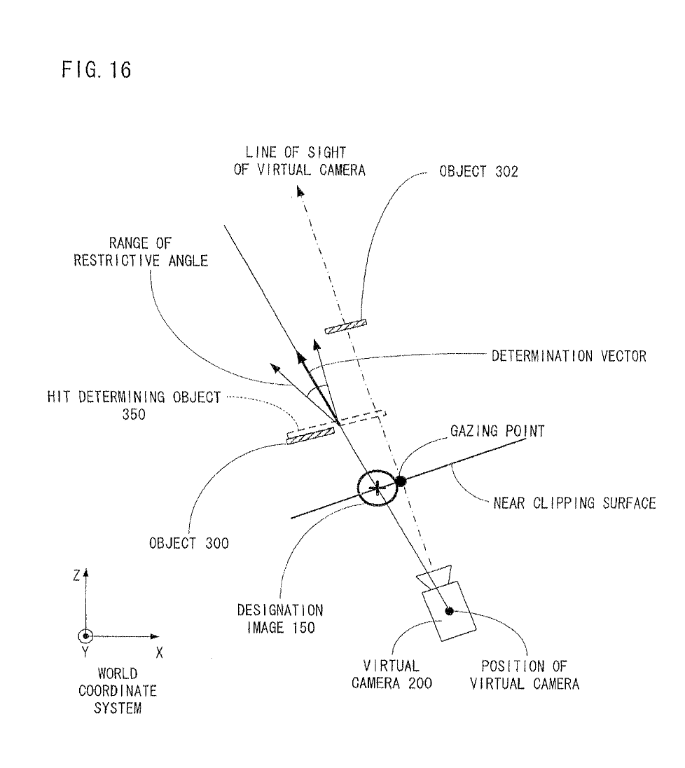

Next, by utilizing FIG. 14-FIG. 16, a method of determining whether the object designated by the player is a correct answer is explained. In this embodiment, as shown in FIG. 14, objects 300 and 302 which construct of a letter or the like the same as the letter or the like as a question are dispersively arranged in the three-dimensional virtual space. Furthermore, an object (hit determining object) 350 for determining whether the correct answer (hit) or not is set by being brought into correspondence with the object having the smallest z coordinate (300, here) out of the objects 300 and 302. In this embodiment, as shown in FIG. 14, on the back side of the object 300, the hit determining object 350 is arranged. Here, in FIG. 14 (this is true for FIG. 15 and FIG. 16), the hit determining object 350 is shown so as to be slightly displaced from the object (300) for clear understanding.

Furthermore, in FIG. 14 (this is true for FIG. 15 and FIG. 16), the hit determining object 350 is used by utilizing the dotted lines, but in reality, the hit determining object 350 is a transparent object, and is never displayed on the game screen 100. In addition, in this embodiment, the hit determining object 350 is set by being brought into correspondence with the object (300 here) having the smallest z coordinate of the position coordinates out of the plurality of objects (300, 302) which construct of a letter or the like the same as the letter or the like as a question, but this may be set to any of the plurality of objects (300, 302) which construct of a letter or the like the same as the letter or the like as a question or may be set in-between the objects. That is, in a case that the player sees from the position as a correct answer, if only the plurality of objects (300, 302) which construct of a letter or the like and the hit determining object 350 are superimposed on the screen, the hit determining object 350 may be arranged (set) anywhere. Furthermore, although it is difficult to understand in the drawing, the hit determining object 350 has a shape the same or approximately the same as the letter or the like as a question, and is set to a size the same or approximately the same as the letter or the like as a question, in this embodiment.

As described above, in this embodiment, when the player puts the designation image 150 on the object and turns the button image 160 on, whether the correct answer or not is determined. In this embodiment, in a case that the position of the virtual camera 200 is set to a predetermined position, a letter or the like as a correct answer is displayed on the game screen 100. Accordingly, in this embodiment, in a case that a straight line passing through the position of the virtual camera 200 and the position of the designation image 150 is at least in contact with the hit determining object 350, whether or not the direction of the vector (determination vector) of the straight line is within a range of a predetermined angle (range of the restrictive angle) is searched. It should be noted that the direction of the determination vector is a direction directed from the virtual camera 200 to the designation image 150. Here, the range of the restrictive angle is the range of the direction of the determination vector in which the letter or the like represented by the object designated by the player can be recognized to match with the letter or the like as a question. That is, this is the range set as a determination vector which is assumed to be calculated when the position (object) is designated in a state that the object taking a shape of a correct answer (letter or the like) can be viewed. By determining whether or not the direction of the determination vector is included in the range of the restrictive angle as well as by performing the contact determination between the determination vector and the hit determining object, when the object taking the shape of the correct answer can be viewed, only the designated object can be determined to be a correct answer.

Thus, the reason why whether the correct answer or not is determined on the basis of the straight line passing through the position of the virtual camera 200 and the position of the designation image 150 is that it is considered that the player views the designation image 150.

Furthermore, as another embodiment, whether the correct answer or not can be determined on the basis of the straight line passing through the position of the virtual camera 200 and the gazing point. In such a case, for the correct answer, the aforementioned range of the restrictive angle is set as a range with respect to the direction of the straight line connecting the position of the virtual camera 200 (position of the eyes of the player) and the gazing point.

In addition, as a still another embodiment, whether the correct answer or not may be determined without designating the object with designation image 150 or without turning the button image 160 on. For example, if a certain period of time (5 seconds, for example) expires from when the direction of the straight line connecting the position of the virtual camera 200 and the gazing point is within the range of the restrictive angle, the correct answer may be determined. In such a case, it is considered that the letter or the like as a question is perceived (gazed) by the player.

For example, in a case shown in FIG. 15, the straight line passing through the position of the virtual camera 200 and the position of the designation image 150 crosses with the hit determining object 350, but the direction of the determination vector does not fall within the range of the restrictive angle. Thus, it is determined that the letter or the like as a question is not represented by the combination between the object 300 and the object 302 on the game screen 100. As shown in FIG. 15 example, since the forward object 300 and the backward object 302 are separately viewed on the real screen not shown, and they are not in a state that the correct shape (letter or the like) of the object can be viewed. That is, in such a case, when the button image 160 is turned on, an incorrect answer is determined.

Furthermore, in a case shown in FIG. 16, the straight line passing through the position of the virtual camera 200 and the position of the designation image 150 crosses with the hit determining object 350, and that, the direction of the determination vector is within the range of the restrictive angle. Thus, it is determined that the letter or the like as a question is represented on the game screen 100 by the combination between the object 300 and the object 302. That is, in such a case, when the button image 160 is turned on, it is determined to be a correct answer.

It should be noted that in FIG. 15 and FIG. 16, only the range of the restrictive angle in the horizontal direction (in the X-Y plane) of the three-dimensional virtual space is shown, but a range of the restrictive angle in the vertical direction (in the X-Y plane) may be set as well. Or, only the range of the restrictive angle in the vertical direction (in the X-Y plane) may be set. These are decided depending on the positions of the virtual camera 200 when the letter or the like as a question is displayed.

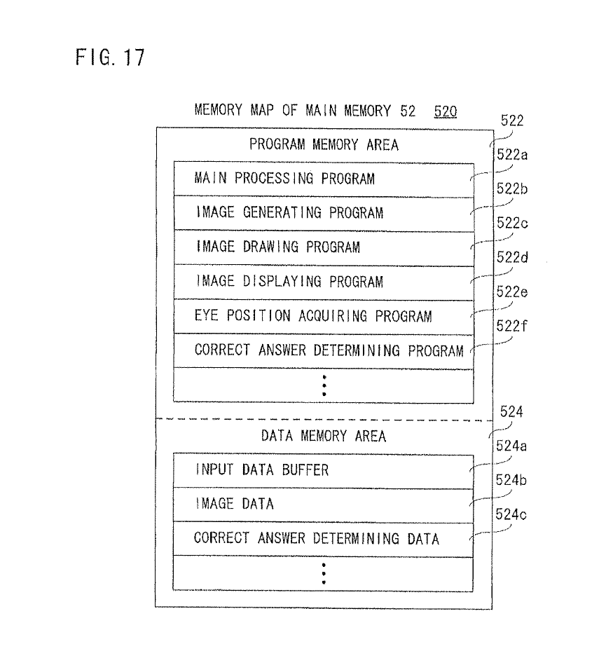

FIG. 17 is an illustrative view showing one example of a memory map 520 of the main memory 52 shown in FIG. 3. As shown in FIG. 17, the main memory 52 includes a program memory area 522 and a data memory area 524. In the program memory area 522, a game program is stored, and the game program is constructed by a main processing program 522a, an image generating program 522b, an image drawing program 522c, an image displaying program 522d, an eye position acquiring program 522e, a correct answer determining program 522f, etc.

The main processing program 522a is a program for performing a main routine of the virtual game of this embodiment. The image generating program 522b is a program for generating game images (executing modeling) to display a game screen (100) by utilizing image data described later. The image drawing program 522c is a program for setting the camera matrix A′, and executing the normal perspective projection transforming processing. The image displaying program 522d is a program for displaying a game image on which the perspective projection transformation is performed according to the image drawing program 522b as a game screen (100) on the first LCD 16 and the second LCD 18.

The eye position acquiring program 522e is a program for extracting a skin color region corresponding to the face of the player from the imaged image by the inward camera 32 as described above, and specifying (acquiring) the position of the eyes on the basis of the extracted skin color region. The correct answer determining program 522f is a program for, in a case that there is a hit determining object 350 to be at least hit with the straight line passing through the position of the virtual camera 200 and the position of the designation image 150 in response to the button image 160 being turned on as described above, determining whether the correct answer not depending on whether or not the direction of the determination vector as to the straight line is within the range of the restrictive angle.

Although illustration is omitted, in the program memory area 522, a backup program and a sound output program are also stored. The backup program is a program for storing game data (proceeding data, result data) in the memory card 26, the memory card 28 or the memory for saved data 56. The sound output program is a program for outputting sound necessary for the game (music) by utilizing sound data (not illustrated), and outputting the same from the speaker.

Furthermore, as shown in FIG. 17, the data memory area 524 is provided with an input data buffer 524a. Moreover, in the data memory area 524, image data 524b and correct answer determining data 524c are stored. In the input data buffer 524a, operation data from the operation button 20 and coordinate data from the touch panel 22 are stored (temporarily stored) in chronological order. The image data 524b is data, such as polygon data, texture data, etc. for generating the above-described game image. The correct answer determining data 524c is data as to each hit determining object 350 set to each letter or the like as a question and data as to each range of the restrictive angle set in correspondence with each hit determining object 350. In this embodiment, the data as to each hit determining object 350 is constructed by transparent polygon data. Furthermore, in the correct answer determining data 524c, the three-dimensional coordinates for arranging each hit determining object 350 in the three-dimensional virtual space are also stored.

Although illustration is omitted, in the data memory area 524, data being necessary for the game like the sound data is stored, and a timer (counter) and a flag necessary for executing the virtual game processing are set.

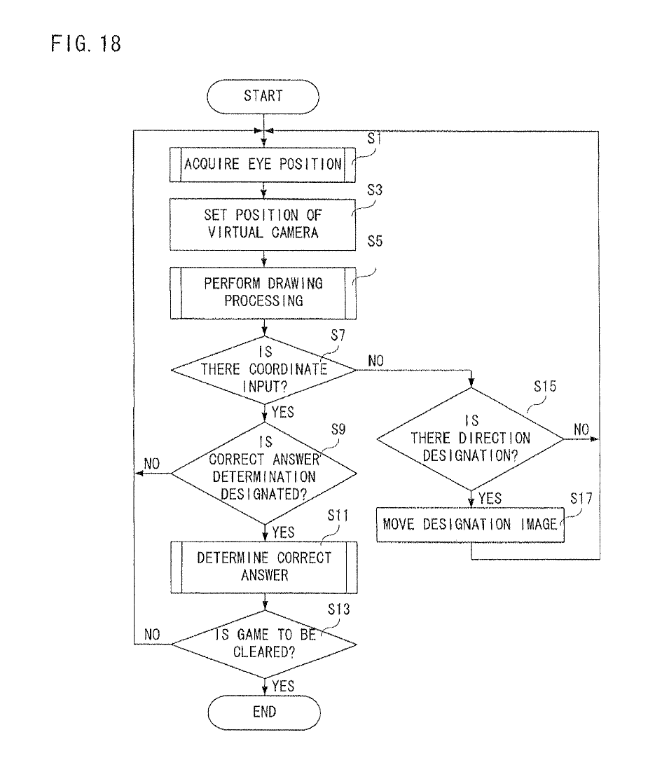

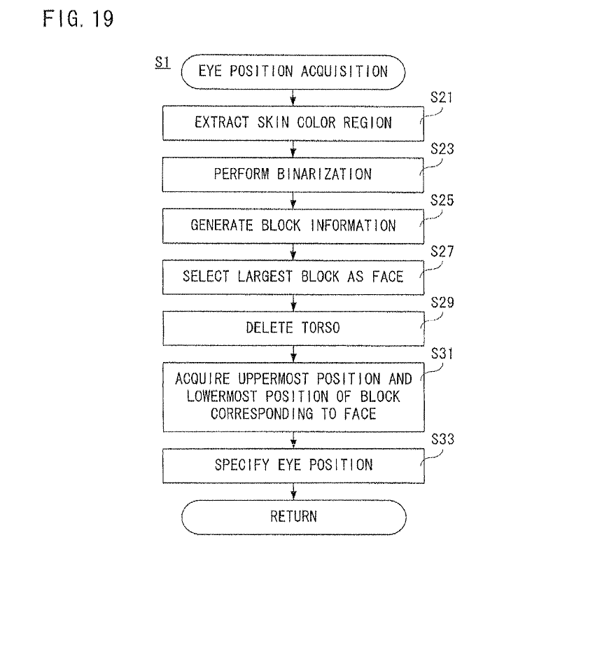

FIG. 18 is a flowchart showing entire processing of the CPU 50 shown in FIG. 3. As shown in FIG. 18, when starting entire processing, the CPU 50 executes eye position acquiring processing (see FIG. 19) described later in a step S1. In a succeeding step S3, a position of the virtual camera 200 is set. Here, depending on the position of the eyes acquired in the step S1, the position of the X-Y plane in the three-dimensional virtual space of the virtual camera 200 is decided, and the position in the Z-axis direction is decided depending on the distance between the gazing point and the position of the virtual camera 200. Here, the orientation of the virtual camera 200 is set to the direction of the gazing point.

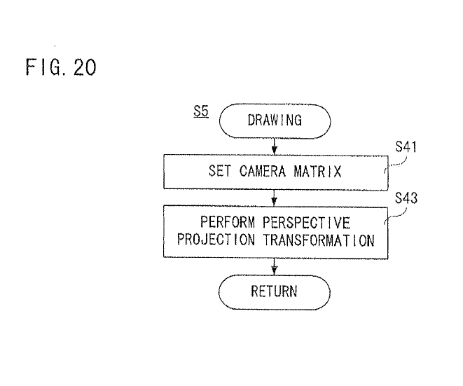

Succeedingly, in a step S5, drawing processing (see FIG. 20) described later is executed. That is, a game image for displaying the game screen 100 in correspondence with the position of the eyes of the player is generated. Although illustration is omitted, when the virtual game is started, prior to the processing in the step S1, a plurality of objects are arranged (modeled) within the range 202 of the three-dimensional virtual space.

In a following step S7, it is determined whether or not there is a coordinate input. Here, the CPU 50 determines whether or not an input (coordinate data) from the touch panel 22 is stored in the input data buffer 524a. If “YES” in the step S7, that is, if there is a coordinate input, it is determined whether a correct answer determination is designated in a step S9. That is, it is determined whether or not the coordinates indicated by the coordinate data on the second LCD 18 is included in the area where the button image 160 is displayed. This makes it possible to determine whether or not the button image 160 is turned on.

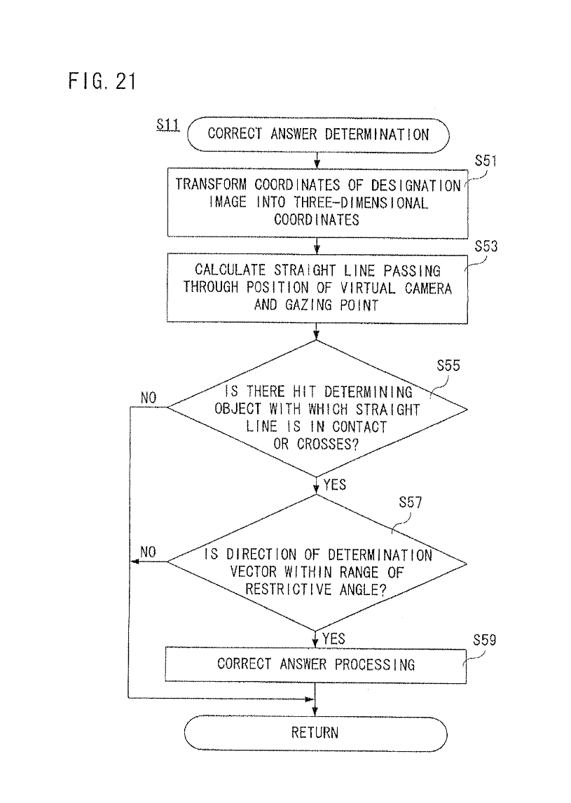

If “NO” in the step S9, that is, if a correct answer determination is not designated, the process returns to the step S1 as it is. On the other hand, if “YES” in the step S9, that is, if a correct answer determination is designated, correct answer determining processing (see FIG. 21) described later is executed in a step S11.

Then, in a step S13, it is determined whether or not the game is to be cleared. In this embodiment, it is determined whether or not all the letters or the like as questions are found. If “NO” in the step S13, that is, if the game is not to be cleared, the process returns to the step S1 as it is. On the other hand, if “YES” in the step S13, that is, if the game is to be cleared, the entire processing is ended as it is.

Alternatively, if “NO” in the step S7, that is, if there is no coordinate input, it is determined whether or not there is a direction designation in a step S15. That is, it is determined whether or not operation data of the direction input button 20a is stored in the input data buffer 524a. If “NO” in the step S15, that is, if there is no a direction designation, the process returns to the step S1 as it is. On the other hand, if “YES” in the step S15, that is, if there is a direction designation, the designation image 150 is moved according to a direction designation in a step S17, and the process returns to the step S1. That is, in the step S17, according to the operation data of the direction input button 20a, the designation image 150 is moved on the projection plane to left, right, top, bottom or oblique direction.

Here, the scan time of the entire processing shown in FIG. 18 is one frame (frame is a screen updating rate ( 1/60 seconds)).

FIG. 19 is a flowchart showing the eye position acquiring processing in the step S1 shown in FIG. 18. As shown in FIG. 19, when starting the eye position acquiring processing, the CPU 50 extracts a skin color region from the imaged image in a step S21. Although illustration is omitted, when the virtual game is started, imaging processing is executed separately from the entire processing to acquire imaged image for each frame, for example. In a next step S23, the images are binarized between the skin color region and the non-skin color region. In a succeeding step S25, block information is generated. That is, the CPU 50, if there are a predetermined number of skin color pixel or more as a block, the block or the range is generated as block information.

Succeedingly, in a step S27, the largest block is selected as a face. In a next step S29, the torso is deleted. That is, a skin-color region which is below the neck and sharply expands the width, that is, the region assumed to be the shoulder is deleted from the block information. The region to be removed is the region of the shoulder, that is, only the wide region and the range below the face. Accordingly, the neck region is not removed. In a succeeding step S31, the uppermost position and the lowermost position of the block corresponding to the face are acquired. That is, the uppermost position of the skin color region corresponds to the uppermost position of the forehead or the parietal region, and the lowermost position corresponds to the tip end of the jaw, so that the uppermost position of the forehead or the parietal region and the tip end position of the jaw are acquired. Then, in a step S33, the position of the eyes is specified, and the process returns to the entire processing shown in FIG. 18. As described above, in the step S33, the CPU 50 specifies the position below the length eighth part of the length between the uppermost position and the lowermost position from the uppermost position as a position of the eyes.

FIG. 20 is a flowchart showing the drawing processing in the step S5 shown in FIG. 18. As shown in FIG. 20, when starting the drawing processing, the CPU 50 sets the camera matrix A′ based on the matrix B shown in the Equation 2 in a step S41. Next, in a step S43, perspective projection transforming processing is executed, and the processing returns to the entire processing shown in FIG. 18.

FIG. 21 is a flowchart showing the correct answer determining processing in the step S11 shown in FIG. 18. As shown in FIG. 21, when starting the correct answer determining processing, the CPU 50 transforms the coordinates of the designation image 150 into the three-dimensional coordinates in a step S51. Here, the XY coordinates of the designation image 150 designated in the two-dimensional projection plane are transformed into the XY coordinates in the X-Y plane of the three-dimensional virtual space, to which the Z coordinate of the projection plane in the three-dimensional virtual space is further added. In a next step S53, a straight line passing through the position of the virtual camera 200 and the position of the gazing point is calculated.

Next, in a step S55, it is determined whether or not there is a straight line calculated in the step S53 which is in contact with or crosses with the hit determining object 350. If “NO” in the step S55, that is, if there is no straight line which is in contact with or crosses with the hit determining object 350, the process returns to the entire processing shown in FIG. 18.

On the other hand, if “YES” in the step S55, that is, if there is a straight line which is in contact with or crosses with the hit determining object 350, it is determined whether or not the direction of the determination vector is within the range of the restrictive angle which is set in correspondence with the hit determining object 350 in a step S57. If “NO” in the step S57, that is, if the direction of the determination vector is outside the range of the restrictive angle, it is determined to be the incorrect answer, and the process returns to the entire processing.

Here, If “NO” in the step S55 or step S57, without directly returning to the entire processing, the incorrect answer may be represented by a display of the game screen 100, an output of a sound (music) or both thereof, and then, the process may be returned to the entire processing.

Furthermore, if “YES” in the step S57, that is, if the direction of the determination vector is within the range of the restrictive angle, the correct answer is determined, the correct answer processing is executed in a step S59, and then, the process returns to the entire processing. For example, in the step S59, the CPU 50 represents the correct answer by a display of the game screen 100, an output of a sound (music) or both thereof. Furthermore, as to the letter or the like correctly answered, a color and a pattern may be given to the part which is translucently displayed on the game screen 100 onward.

According to this embodiment, the virtual camera is controlled by the position of the eyes of the player specified by the imaged image to allow the player to find the letter or the like hidden under the game screen, so that the posture of the player himself or herself can be efficiently utilized in the game. Furthermore, in this embodiment, by controlling the virtual camera such that the three-dimensional virtual space is fixed with respect to the display surface, the player can view the three-dimensional virtual space in a three-dimensional manner even in the two-dimensional screen display.

Additionally, in this embodiment, only the virtual game for which the letter or the like hidden under the three-dimensional virtual space is found by controlling the position of virtual camera is explained, there is no need of being restricted thereto. For example, this can be applied to a first-person shooting game in which the player takes a sight (designation image) on an arbitrary character hidden under the three-dimensional virtual space in order to attack the character with arms like a gun.

Furthermore, in this embodiment, the position of the eyes of the player is specified from the imaged image, but there is no need of being restricted thereto. For example, the position of the eyebrow is specified, and in correspondence with the position thereof, the position of virtual camera may be controlled. Or, a mark like a seal with a predetermined color (other than skin color) is pasted around the eyebrow, the position of the mark is specified from the imaged image, and in correspondence with the position, the position of the virtual camera may be controlled.

In addition, the configuration of the game apparatus need not be restricted to that of the embodiment. One camera may be provided, for example. Alternatively, the touch panel may not be provided. Still alternatively, the touch panel may be provided on the two LCDs.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A handheld game apparatus comprising:
a housing configured to be held by a user;
a display;
a touch panel on the display;
an inward camera disposed within the housing; and
a processor configured to:
specify a position of eyes of the user based on an image captured by the built-in camera,
control a virtual camera in a virtual space according to the position of the eyes of the user,
generate a three-dimensional virtual space image of the virtual space based on a perspective of the virtual camera, and
display the three-dimensional virtual space image on the display.

2. The handheld game apparatus according to claim 1, wherein a gazing point of the virtual camera is fixed during controlling the virtual camera.

3. The handheld game apparatus according to claim 2, wherein a distance between the virtual camera and the gazing point is maintained constant.

4. The handheld game apparatus according to claim 1, wherein the perspective of the virtual camera is changed in accordance with a change of the position of the eyes of the user.

5. The handheld game apparatus according to claim 1, wherein the virtual camera is set on a plane being in parallel with a plane including a point in the virtual space.

6. The handheld game apparatus according to claim 1, further comprising: an operation button, wherein the game processing performed based on the operation button and the input to the touch panel.

7. The handheld game apparatus according to claim 5, wherein the operation button is used for inputting a direction.

8. The handheld game apparatus according to claim 1, further comprising: a camera, wherein an imaging direction of the camera is opposite to an imaging direction of the built-in camera.

9. The handheld game apparatus according to claim 1, further comprising: a wireless communication device.

10. The handheld game apparatus according to claim 1, wherein the display includes a first display unit and a second display unit.

11. The handheld game apparatus according to claim 1, wherein the handheld game apparatus is foldable.

12. The handheld game apparatus according to claim 1, further comprising: a speaker.

13. The handheld game apparatus according to claim 1, further comprising: a microphone.

14. The handheld game apparatus according to claim 1, further comprising: a slot for housing a memory card.

15. The handheld game apparatus according to claim 1, further comprising: a LED.

16. The handheld game apparatus according to claim 1, wherein a button image displayed on the display for the input to the touch panel.

17. The handheld game apparatus according to claim 1, wherein the processor is further configured to perform game processing based on at least an input to the touch panel.

18. A handheld information processing apparatus, comprising:
a housing configured to be held by a user;
a display device having a touch panel on at least a portion of the display device;
at least one inward camera disposed on a first surface of the housing; and
a processing system having at least one processor, the processing system configured to:
recognize one or more facial features of the user imaged by the at least one inward camera to specify a position of eyes of the user relative to the housing of the handheld information processing apparatus,
generate a three-dimensional image of a virtual space from a perspective of a virtual camera determined based on the specified position of the eyes of the user, and
display the generated three-dimensional image on the display device.

19. The handheld information processing apparatus of claim 18, wherein the perspective of the virtual camera changes corresponding to a change in position of the eyes of the user.

20. The handheld information processing apparatus of claim 18, where the processing system is further configured to:
control a position of the virtual camera in the virtual space to correspond to the specified position of the eyes of the user; and
generate the three-dimensional image based on the position of the virtual camera.

21. The handheld information processing apparatus of claim 20, wherein the position of the virtual camera changes corresponding to a posture of the user with respect to an orientation of the housing of the handheld information processing apparatus.

22. The handheld information processing apparatus of claim 20, wherein the position of the virtual camera corresponds to a gaze of the user determined based on the specified position of the eyes of the user.
